(19) United States
(12) Patent Application Publication
(10) Pub. No.: US 2026/0094559 A1
(43) Pub. Date: Apr. 2, 2026

(54) GATE DRIVER, DISPLAY DEVICE INCLUDING THE GATE DRIVER AND ELECTRONIC DEVICE INCLUDING THE DISPLAY DEVICE

(71) Applicants: Samsung Display Co., LTD., Yongin-si (KR); Konkuk University Industrial Cooperation Corp., Seoul (KR)

(72) Inventors: Sanghun Kim, Yongin-si (KR); SangWoon Lee, Seoul (KR); KeeChan Park, Seoul (KR); NACKHYEON KEUM, Yongin-si (KR); KYUNG-HOON KIM, Yongin-si (KR); HEERIM SONG, Yongin-si (KR)

(21) Appl. No.: 19/243,993

(22) Filed: Jun. 20, 2025

(30) Foreign Application Priority Data
Sep. 30, 2024 (KR) 10-2024-0133173

(51) Int. Cl. G09G 3/32

(52) U.S. Cl. CPC G09G 3/32; G09G 2310/0267; G09G 2310/08; G09G 2330/021

(57) ABSTRACT

A gate driver includes an input circuit which transmits an input signal to a control circuit based on a first clock signal, the control circuit which controls a voltage of a control node based on the input signal, the first clock signal, a second clock signal, and a voltage control signal, and an output circuit which outputs a gate signal based on the voltage of the control node. The control circuit transmits one of the first power supply voltage and the second power supply voltage to the control node, and the output circuit outputs one of the first power supply voltage and a third power supply voltage as the gate signal.

This application claims priority to Korean Patent Application No. 10-2024-0133173, filed on Sep. 30, 2024, and all the benefits accruing therefrom under 35 U.S. C. § 119, the content of which in its entirety is herein incorporated by reference.

### BACKGROUND

### 1. Field

Embodiments supported by the present disclosure relate to a gate driver and a display device including the gate driver.

### 2. Description of the Related Art

A display device may include a display panel and a display panel driver. The display panel may include a plurality of gate lines, a plurality of emission lines, a plurality of data lines, and a plurality of pixels. The display panel driver may include a gate driver providing gate signals to the gate lines, an emission driver providing emission signals to the emission lines, a data driver providing data voltages to the data lines, and a driving controller controlling the gate driver, the emission driver, and the data driver.

In some cases, as the size of a transistor included in the gate driver increases, a capacitance of a parasitic capacitor associated with the gate driver may increase, and power consumption of the display device due to charging and discharging of the parasitic capacitor may increase.

### SUMMARY

Embodiments supported by the present disclosure provide a gate driver which reduces power consumption of a display device and having improved stability.

Embodiments supported by the present disclosure provide a display device including the gate driver.

Embodiments supported by the present disclosure provide an electronic device including the display device.

In an embodiment of a gate driver according to the present disclosure, the gate driver includes an input circuit which transmits an input signal to a control circuit based on a first clock signal, the control circuit which controls a voltage of a control node based on the input signal, the first clock signal, a second clock signal, and a voltage control signal, and an output circuit which outputs a gate signal based on the voltage of the control node. The control circuit includes a fifth transistor including a control electrode connected to a second node, a first electrode which receives a first power supply voltage, and a second electrode connected to the control node, a sixth transistor including a control electrode connected to a fourth node, a first electrode connected to the control node, and a second electrode which receives a second power supply voltage, a ninth transistor including a control electrode which receives the voltage control signal, a first electrode connected to a third node, and a second electrode connected to the fourth node, the control circuit transmits one of the first power supply voltage and the second power supply voltage to the control node, and the output circuit outputs one of the first power supply voltage and a third power supply voltage as the gate signal.

In an embodiment, the input circuit may include a first transistor including a control electrode which receives the first clock signal, a first electrode which receives the input signal, and a second electrode connected to a first node, and the control circuit may further include a second transistor including a control electrode which receives the third power supply voltage, a first electrode connected to the first node, and a second electrode connected to the third node, a third transistor including a control electrode connected to the third node, a first electrode which receives the second clock signal, and a second electrode connected to the second node, a fourth transistor including a control electrode which receives the first clock signal, a first electrode which receives the first power supply voltage, and a second electrode connected to the second node, a first capacitor including a first electrode connected to the second node and a second electrode connected to the third node, a second capacitor including a first electrode which receives the first power supply voltage and a second electrode connected to the second node, and a third capacitor including a first electrode connected to the second node and a second electrode connected to the fourth node.

In an embodiment, the output circuit may include a seventh transistor including a control electrode connected to the control node, a first electrode which receives the first power supply voltage, and a second electrode connected to an output node, and an eighth transistor including a control electrode connected to the control node, a first electrode connected to the output node, and a second electrode which receives the third power supply voltage.

In an embodiment, a level of the first power supply voltage may be higher than a level of the third power supply voltage, and the level of the third power supply voltage may be higher than a level of the second power supply voltage.

In an embodiment, the sixth transistor, the eighth transistor, and the ninth transistor may be implemented as transistors of a first type, and the first transistor to the fifth transistor and the seventh transistor may be implemented as transistors of a second type which are different from the transistors of the first type.

In an embodiment, the sixth transistor, the eighth transistor, and the ninth transistor may be implemented as N-type transistors.

In an embodiment, the first transistor to the fifth transistor and the seventh transistor may be implemented as P-type transistors.

In an embodiment, the sixth transistor may further include a second control electrode connected to the control electrode of the sixth transistor, the eighth transistor may further include a second control electrode connected to the control electrode of the eighth transistor, and the ninth transistor may further include a second control electrode connected to the control electrode of the ninth transistor.

In an embodiment of a display device according to the present disclosure, the display device includes a display panel including pixels, a gate driver which outputs a gate signal to the pixels, and a data driver which outputs a data voltage to the pixels. The gate driver includes an input circuit which transmits an input signal to a control circuit based on a first clock signal, the control circuit which controls a voltage of a control node based on the input signal, the first clock signal, a second clock signal, and a voltage control signal, and an output circuit which outputs the gate signal based on the voltage of the control node, the control circuit includes a fifth transistor including a control electrode connected to a second node, a first electrode which receives a first power supply voltage, and a second electrode connected to the control node, a sixth transistor including a control electrode connected to a fourth node, a first electrode connected to the control node, and a second electrode which receives a second power supply voltage, a ninth transistor including a control electrode which receives the voltage control signal, a first electrode connected to a third node, and a second electrode connected to the fourth node, the control circuit transmits one of the first power supply voltage and the second power supply voltage to the control node, and the output circuit outputs one of the first power supply voltage and a third power supply voltage as the gate signal.

In an embodiment, the input circuit may include a first transistor including a control electrode which receives the first clock signal, a first electrode which receives the input signal, and a second electrode connected to a first node, and the control circuit may further include a second transistor including a control electrode which receives the third power supply voltage, a first electrode connected to the first node, and a second electrode connected to the third node, a third transistor including a control electrode connected to the third node, a first electrode which receives the second clock signal, and a second electrode connected to the second node, a fourth transistor including a control electrode which receives the first clock signal, a first electrode which receives the first power supply voltage, and a second electrode connected to the second node, a first capacitor including a first electrode connected to the second node and a second electrode connected to the third node, a second capacitor including a first electrode which receives the first power supply voltage and a second electrode connected to the second node, and a third capacitor including a first electrode connected to the second node and a second electrode connected to the fourth node.

In an embodiment, the output circuit may include a seventh transistor including a control electrode connected to the control node, a first electrode which receives the first power supply voltage, and a second electrode connected to an output node, and an eighth transistor including a control electrode connected to the control node, a first electrode connected to the output node, and a second electrode which receives the third power supply voltage.

In an embodiment, a level of the first power supply voltage may be higher than a level of the third power supply voltage, and the level of the third power supply voltage may be higher than a level of the second power supply voltage.

In an embodiment, the sixth transistor, the eighth transistor, and the ninth transistor may be implemented as transistors of a first type, and the first transistor to the fifth transistor and the seventh transistor may be implemented as transistors of a second type which are different from the transistors of the first type.

In an embodiment, the sixth transistor, the eighth transistor, and the ninth transistor may be implemented as N-type transistors.

In an embodiment, the first transistor to the fifth transistor and the seventh transistor may be implemented as P-type transistors.

In an embodiment, the sixth transistor may further include a second control electrode connected to the control electrode of the sixth transistor, the eighth transistor may further include a second control electrode connected to the control electrode of the eighth transistor, and the ninth transistor may further include a second control electrode connected to the control electrode of the ninth transistor.

In an embodiment of an electronic device according to the present disclosure, the electronic device includes a processor which outputs an input control signal and input image data, a display panel including pixels, a gate driver which outputs a gate signal to the pixels, a data driver which outputs a data voltage to the pixels, and a driving controller which controls the gate driver and the data driver based on the input control signal and the input image data. The gate driver includes an input circuit which transmits an input signal to a control circuit based on a first clock signal, the control circuit which controls a voltage of a control node based on the input signal, the first clock signal, a second clock signal, and a voltage control signal, and an output circuit which outputs the gate signal based on the voltage of the control node, the control circuit includes a fifth transistor including a control electrode connected to a second node, a first electrode which receives a first power supply voltage, and a second electrode connected to the control node, a sixth transistor including a control electrode connected to a fourth node, a first electrode connected to the control node, and a second electrode which receives a second power supply voltage, a ninth transistor including a control electrode which receives the voltage control signal, a first electrode connected to a third node, and a second electrode connected to the fourth node, the control circuit transmits one of the first power supply voltage and the second power supply voltage to the control node, and the output circuit outputs one of the first power supply voltage and a third power supply voltage as the gate signal.

In an embodiment, the input circuit may include a first transistor including a control electrode which receives the first clock signal, a first electrode which receives the input signal, and a second electrode connected to a first node, and the control circuit may further include a second transistor including a control electrode which receives the third power supply voltage, a first electrode connected to the first node, and a second electrode connected to the third node, a third transistor including a control electrode connected to the third node, a first electrode which receives the second clock signal, and a second electrode connected to the second node, a fourth transistor including a control electrode which receives the first clock signal, a first electrode which receives the first power supply voltage, and a second electrode connected to the second node, a first capacitor including a first electrode connected to the second node and a second electrode connected to the third node, a second capacitor including a first electrode which receives the first power supply voltage and a second electrode connected to the second node, and a third capacitor including a first electrode connected to the second node and a second electrode connected to the fourth node.

In an embodiment, the output circuit may include a seventh transistor including a control electrode connected to the control node, a first electrode which receives the first power supply voltage, and a second electrode connected to an output node, and an eighth transistor including a control electrode connected to the control node, a first electrode connected to the output node, and a second electrode which receives the third power supply voltage.

In an embodiment, a level of the first power supply voltage may be higher than a level of the third power supply voltage, and the level of the third power supply voltage may be higher than a level of the second power supply voltage.

According to embodiments of the present disclosure, the gate driver may include the first transistor to the ninth transistor and the first capacitor to the third capacitor. The sixth transistor, the eighth transistor, and the ninth transistor may be implemented as N-type transistors and the first transistor to the fifth transistor and the seventh transistor may be implemented as P-type transistors.

In an example in which sixth transistor, the eighth transistor, and the ninth transistor are implemented as N-type transistors (e.g. N-type metal oxide thin film transistors), turn-off characteristics of the sixth transistor, the eighth transistor, and the ninth transistor may be improved. Accordingly, a leakage current of each of the sixth transistor, the eighth transistor, and the ninth transistor may be decreased. Accordingly, the gate driver may stably output the carry signal or the gate signal. Accordingly, a stability of the gate driver may be improved and a stability of the display device including the gate driver may be improved. In some aspects, as the leakage current of each of the sixth transistor, the eighth transistor, and the ninth transistor are decreased, power consumption of the display device may be reduced.

In an example in which sixth transistor, the eighth transistor, and the ninth transistor are implemented as N-type transistors (e.g. the N-type metal oxide thin film transistor), the number of the transistors included in the gate driver may be decreased compared to a conventional gate driver. Accordingly, dead space of the display device including the gate driver may be decreased and the power consumption of the display device may be reduced. In some aspects, an integration density of the display device may be increased.

Clock signal lines connected to the gate driver may be connected to P-type transistors having sizes smaller than sizes of the N-type transistors. Accordingly, a capacitance of each of parasitic capacitors formed by the clock signal lines and the P-type transistors may be decreased. Accordingly, the power consumption of the display device due to charging and discharging of the parasitic capacitors may be reduced and the power consumption of the display device may be reduced.

In some aspects, in an example in which the first transistor to the fifth transistor, and the seventh transistor are implemented as P-type transistors (e.g. the P-type LTPS thin film transistors), a magnitude of a current flowing through each of the first transistor to the fifth transistor, and the seventh transistor may be large. Accordingly, the stability of the gate driver may be improved and the stability of the display device including the gate driver may be improved.

### BRIEF DESCRIPTION OF THE DRAWINGS

The above and other features and advantages of the inventive concept will become more apparent by describing in detailed embodiments thereof with reference to the accompanying drawings, in which:

FIG. 1 is a block diagram illustrating a display device according to embodiments of the present disclosure;

FIG. 2 is a block diagram illustrating an embodiment of stages included in a gate driver of FIG. 1;

FIG. 3 is a circuit diagram illustrating an embodiment of a stage of FIG. 2;

FIG. 4 is a timing diagram illustrating an embodiment of an operation of the stage of FIG. 3;

FIG. 5 is a circuit diagram illustrating the operation of the stage of FIG. 3 in a first period of the timing diagram of FIG. 4;

FIG. 6 is a circuit diagram illustrating the operation of the stage of FIG. 3 in a second period of the timing diagram of FIG. 4;

FIG. 7 is a circuit diagram illustrating the operation of the stage of FIG. 3 in a third period of the timing diagram of FIG. 4;

FIG. 8 is a circuit diagram illustrating the operation of the stage of FIG. 3 in a fourth period of the timing diagram of FIG. 4;

FIG. 9 is a circuit diagram illustrating an embodiment of a stage of FIG. 2;

FIG. 10 is a block diagram illustrating an embodiment of stages included in the gate driver of FIG. 1;

FIG. 11 is a circuit diagram illustrating an embodiment of a stage of FIG. 10;

FIG. 12 is a timing diagram illustrating an embodiment of an operation of the stage of FIG. 11;

FIG. 13 is a circuit diagram illustrating an embodiment of a stage of FIG. 10;

FIG. 14 is a circuit diagram illustrating an embodiment of a pixel included in a display panel of FIG. 1;

FIG. 15 is a block diagram illustrating an electronic device according to embodiments of the present disclosure; and

FIG. 16 is a diagram illustrating an embodiment in which the electronic device of FIG. 15 is implemented as a smart phone.

### DETAILED DESCRIPTION

Hereinafter, display devices in accordance with embodiments will be described in more detail with reference to the accompanying drawings. The same reference numerals are used for the same components in the drawings, and redundant descriptions of the same components will be omitted.

Aspects supported by the present disclosure may, however, be embodied in different forms and should not be construed as limited to the embodiments set forth herein. Rather, these example embodiments are provided so that this disclosure will be thorough and complete, and will fully convey the scope of example aspects of the invention to those skilled in the art.

Terms such as, for example, first, second, and the like may be used to describe various components, but the components should not be limited by the terms. The terms as used herein may distinguish one component from other components and are not to be limited by the terms. For example, without departing the scope of the present disclosure, a first component may be referred to as a second component, and similarly, the second component may also be referred to as the first component. The terms of a singular form may include plural forms unless otherwise specified.

The terminology used herein is for the purpose of describing particular embodiments and is not intended to be limiting. As used herein, “a,” “an,” “the,” and “at least one” do not denote a limitation of quantity, and are intended to include both the singular and plural, unless the context clearly indicates otherwise. For example, “an element” has the same meaning as “at least one element,” unless the context clearly indicates otherwise. “At least one” is not to be construed as limiting “a” or “an.” “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, comp

The terms “about” or “approximately” as used herein are inclusive of the stated value and include a suitable range of deviation for the particular value as determined by one of ordinary skill in the art, considering the measurement in question and the error associated with measurement of the particular quantity. The term “about” can mean within one or more standard deviations, or within ±30%, 20%, 10%, 5% of the stated value, for example.

The term “substantially,” as used herein, means approximately or actually. The term “substantially equal” means approximately or actually equal. The term “substantially the same” means approximately or actually the same. The term “substantially identical” means approximately or actually identical. The term “substantially perpendicular” means approximately or actually perpendicular.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the term “below” can encompass both an orientation of above and below. The device may be otherwise oriented (rotated 90 degrees or at other orientations) and the spatially relative descriptors used herein interpreted accordingly.

Embodiments are described herein with reference to cross section illustrations that are schematic illustrations of example embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

It should be appreciated that various embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B”, “at least one of A and B”, “at least one of A or B”, “A, B, or C”, “at least one of A, B, and C”, and “at least one of A, B, or C”, may include any one of, or all possible combinations of the items enumerated together in a corresponding one of the phrases.

It is to be understood that if an element (e.g., a first element) is referred to, with or without the term “operatively” or “communicatively”, as “coupled with”, “coupled to”, “connected with”, or “connected to” another element (e.g., a second element), it means that the element may be coupled with the other element directly (e.g., wiredly), wirelessly, or via a third element.

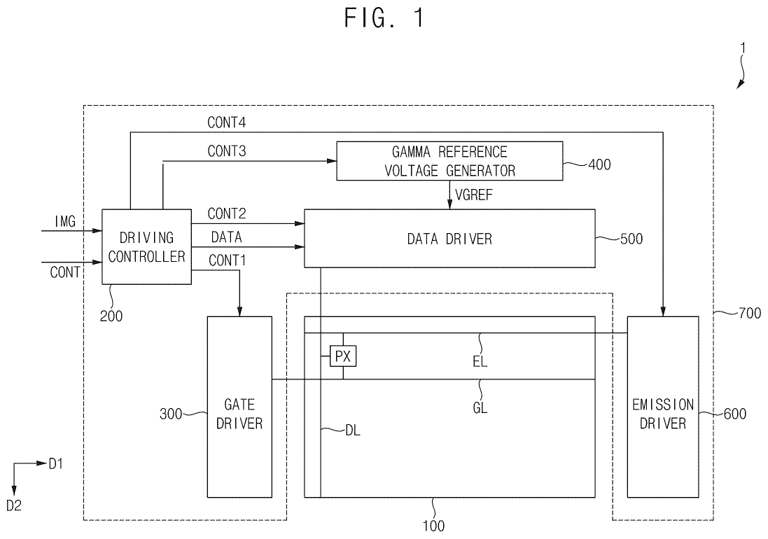

FIG. 1 is a block diagram illustrating a display device 1 according to embodiments of the present disclosure.

Referring to FIG. 1, the display device 1 includes a display panel 100 and a display panel driver 700. The display panel driver 700 may include a driving controller 200, a gate driver 300, a gamma reference voltage generator 400, a data driver 500, and an emission driver 600.

The display panel 100 may include a display region on which an image is displayed and a peripheral region adjacent to the display region.

The display panel 100 includes a plurality of gate lines GL, a plurality of data lines DL, a plurality of emission lines EL, and a plurality of pixels PX electrically connected to each of the gate lines GL, the data lines DL, and the emission lines EL. The gate lines GL may extend in a first direction D1, the data lines DL may extend in a second direction D2 crossing the first direction D1, and the emission lines EL may extend in the first direction D1.

The driving controller 200 may receive input image data IMG and an input control signal CONT from an external device. For example, the input image data IMG may include red image data, green image data and blue image data. In some embodiments, the input image data IMG may further include white image data. In another example, the input image data IMG may include magenta image data, yellow image data, and cyan image data. The input control signal CONT may include a master clock signal and a data enable signal. The input control signal CONT may further include a vertical synchronizing signal and a horizontal synchronizing signal.

The driving controller 200 may generate a first control signal CONT1, a second control signal CONT2, a third control signal CONT3, a fourth control signal CONT4, and a data signal DATA based on the input image data IMG and the input control signal CONT.

The driving controller 200 may generate the first control signal CONT1 for controlling an operation of the gate driver 300 based on the input control signal CONT, and may output the first control signal CONT1 to the gate driver 300. The first control signal CONT1 may include a vertical start signal and a gate clock signal.

The driving controller 200 may generate the second control signal CONT2 for controlling an operation of the data driver 500 based on the input control signal CONT, and may output the second control signal CONT2 to the data driver 500. The second control signal CONT2 may include a horizontal start signal and a load signal.

The driving controller 200 may generate the data signal DATA based on the input image data IMG. The driving controller 200 may output the data signal DATA to the data driver 500.

The driving controller 200 may generate the third control signal CONT3 for controlling an operation of the gamma reference voltage generator 400 based on the input control signal CONT, and may output the third control signal CONT3 to the gamma reference voltage generator 400.

The driving controller 200 may generate the fourth control signal CONT4 for controlling an operation of the emission driver 600 based on the input control signal CONT, and may output the fourth control signal CONT4 to the emission driver 600.

The gate driver 300 may generate gate signals for driving the gate lines GL in response to the first control signal CONT1 received from the driving controller 200. The gate driver 300 may output the gate signals to the gate lines GL. For example, the gate signals may include a writing gate signal, a compensation gate signal, and an initialization gate signal.

In an embodiment, the gate driver 300 may be integrated on the peripheral region of the display panel 100. In an embodiment, the gate driver 300 may be mounted on the peripheral region of the display panel 100.

The gamma reference voltage generator 400 may generate a gamma reference voltage VGREF in response to the third control signal CONT3 received from the driving controller 200. The gamma reference voltage generator 400 may output the gamma reference voltage VGREF to the data driver 500. The gamma reference voltage VGREF may correspond to the data signal DATA.

In an embodiment, the gamma reference voltage generator 400 may be disposed in the driving controller 200, or in the data driver 500.

The data driver 500 may receive the second control signal CONT2 and the data signal DATA from the driving controller 200, and may receive the gamma reference voltages VGREF from the gamma reference voltage generator 400. The data driver 500 may convert the data signals DATA having a digital type into data voltages having an analog type using the gamma reference voltages VGREF. The data driver 500 may output the data voltages to the data lines DL.

In an embodiment, the data driver 500 may be integrated on the peripheral region of the display panel 100. In an embodiment, the data driver 500 may be mounted on the peripheral region of the display panel 100.

The emission driver 600 may generate emission signals for driving the emission lines EL in response to the fourth control signal CONT4 received from the driving controller 200. The emission driver 600 may output the emission signals to the emission lines EL.

In an embodiment, the emission driver 600 may be integrated on the peripheral region of the display panel 100. In an embodiment, the emission driver 600 may be mounted on the peripheral region of the display panel 100.

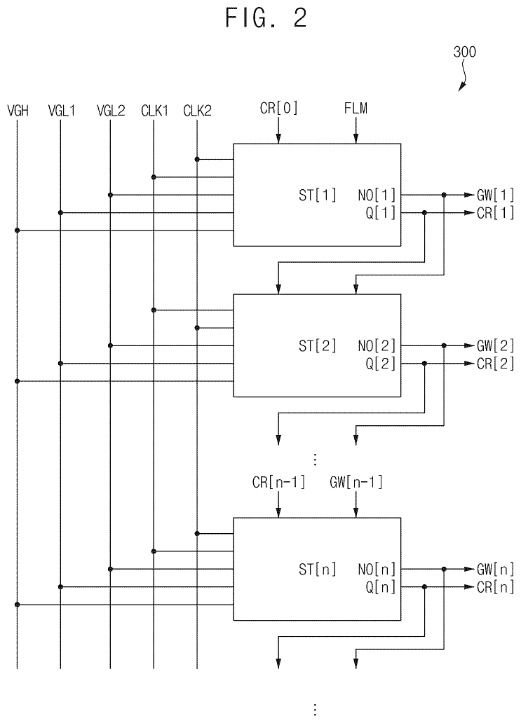

FIG. 2 is a block diagram illustrating an embodiment of stages included in the gate driver 300 of FIG. 1.

Referring to FIG. 2, the gate driver 300 may include the stages. For example, the gate driver 300 may include a first stage ST[1] and a second stage ST[2]. In some aspects, the gate driver 300 may include an n-th stage ST[n], where n is an integer greater than or equal to 2.

Each of the stages may receive a first power supply voltage VGH, a second power supply voltage VGL2, and a third power supply voltage VGL1. In some aspects, each of the stages may receive a first clock signal CLK1 and a second clock signal CLK2.

A level of the first power supply voltage VGH may be higher than a level of the third power supply voltage VGL1. The level of the third power supply voltage VGL1 may be higher than a level of the second power supply voltage VGL2. Expressed another way, the first power supply voltage VGH may be higher than the third power supply voltage VGL1, and the third power supply voltage VGL1 may be higher than the second power supply voltage VGL2.

Each of the stages may receive an input signal and a voltage control signal. The input signal may be a start signal FLM or the gate signal of a previous stage. In some aspects, the voltage control signal may be a start carry signal CR[0] or a carry signal of the previous stage. For example, the carry signal of the previous stage applied to the second stage ST[2] may be a first carry signal CR[1].

The first stage ST[1] may receive the first power supply voltage VGH, the second power supply voltage VGL2, the third power supply voltage VGL1, the first clock signal CLK1, and the second clock signal CLK2. In some aspects, the first stage ST[1] may receive the start signal FLM and the start carry signal CR[0]. The first stage ST[1] may output the first carry signal CR[1] at a first control node Q[1]. In some aspects, the first stage ST[1] may output a first gate signal GW[1] at a first output node NO[1].

The second stage ST[2] may receive the first power supply voltage VGH, the second power supply voltage VGL2, the third power supply voltage VGL1, the first clock signal CLK1, and the second clock signal CLK2. In some aspects, the second stage ST[2] may receive the first gate signal GW[1] and the voltage control signal. The voltage control signal applied to the second stage ST[2] may be the first carry signal CR[1]. The second stage ST[2] may output a second carry signal CR[2] at a second control node Q[2]. In some aspects, the second stage ST[2] may output a second gate signal GW[2] at a second output node NO[2].

In this way, the n-th stage ST[n] may receive the first power supply voltage VGH, the second power supply voltage VGL2, the third power supply voltage VGL1, the first clock signal CLK1, and the second clock signal CLK2. In some aspects, the n-th stage ST[n] may receive an (n−1)-th gate signal GW[n−1] and the voltage control signal. The voltage control signal applied to the n-th stage ST[n] may be an (n−1)-th carry signal CR[n−1]. The n-th stage ST[n] may output an n-th carry signal CR[n] at an n-th control node Q[n]. In some aspects, the n-th stage ST[n] may output an n-th gate signal GW[n] at an n-th output node NO[n].

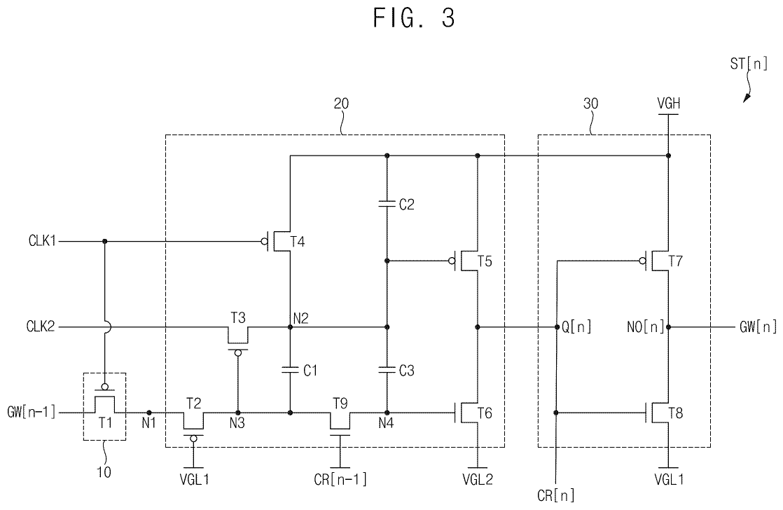

FIG. 3 is a circuit diagram illustrating an embodiment of a stage of FIG. 2.

For convenience of explanation, the stage is the n-th stage ST[n] which receives the (n−1)-th carry signal CR[n−1] and the (n−1)-th gate signal GW[n−1] in the present embodiment.

Referring to FIG. 3, the n-th stage ST[n] may include an input circuit 10, a control circuit 20, and an output circuit 30.

The input circuit 10 may transmit the (n−1)-th gate signal GW[n−1] to a first node N1 based on the first clock signal CLK1.

The input circuit 10 may include a first transistor T1.

The first transistor T1 may include a control electrode receiving the first clock signal CLK1, a first electrode receiving the (n−1)-th gate signal GW[n−1], and a second electrode connected to the first node N1.

The control circuit 20 may control a voltage of the n-th control node Q[n] based on the (n−1)-th gate signal GW[n−1], the first clock signal CLK1, the second clock signal CLK2, and the (n−1)-th carry signal CR[n−1]. In some aspects, the control circuit 20 may output the voltage of the n-th control node Q[n] as the n-th carry signal CR[n].

The control circuit 20 may include a second transistor T2 to a sixth transistor T6, a ninth transistor T9, and a first capacitor C1 to a third capacitor C3.

The second transistor T2 may include a control electrode receiving the third power supply voltage VGL1, a first electrode connected to the first node N1, and a second electrode connected to a third node N3.

The third transistor T3 may include a control electrode connected to the third node N3, a first electrode receiving the second clock signal CLK2, and a second electrode connected to a second node N2.

The fourth transistor T4 may include a control electrode receiving the first clock signal CLK1, a first electrode receiving the first power supply voltage VGH, and a second electrode connected to the second node N2.

The fifth transistor T5 may include a control electrode connected to the second node N2, a first electrode receiving the first power supply voltage VGH, and a second electrode connected to the n-th control node Q[n].

The sixth transistor T6 may include a control electrode connected to a fourth node N4, a first electrode connected to the n-th control node Q[n], and a second electrode receiving the second power supply voltage VGL2.

The ninth transistor T9 may include a control electrode receiving the (n−1)-th carry signal CR[n−1], a first electrode connected to the third node N3, and a second electrode connected to the fourth node N4.

The first capacitor C1 may include a first electrode connected to the second node N2 and a second electrode connected to the third node N3.

The second capacitor C2 may include a first electrode receiving the first power supply voltage VGH and a second electrode connected to the second node N2.

The third capacitor C3 may include a first electrode connected to the second node N2 and a second electrode connected to the fourth node N4.

The output circuit 30 may output the n-th gate signal GW[n] at the n-th output node NO[n] based on the voltage of the n-th control node Q[n].

The output circuit 30 may include a seventh transistor T7 and an eighth transistor T8.

The seventh transistor T7 may include a control electrode connected to the n-th control node Q[n], a first electrode receiving the first power supply voltage VGH, and a second electrode connected to the n-th output node NO[n].

The eighth transistor T8 may include a control electrode connected to the n-th control node Q[n], a first electrode connected to the n-th output node NO[n], and a second electrode receiving the third power supply voltage VGL1. The control electrodes described with reference to the first transistor T1 through the eighth transistor T8 may be gate electrodes which respectively control the flow of current through the first transistor T1 through the eighth transistor T8.

The level of the first power supply voltage VGH may be higher than the level of the third power supply voltage VGL1. The level of the third power supply voltage VGL1 may be higher than the level of the second power supply voltage VGL2.

The sixth transistor T6, the eighth transistor T8, and the ninth transistor T9 may be implemented as transistors of a first type. In some embodiments, the first transistor T1 to the fifth transistor T5 and the seventh transistor T7 may be implemented as transistors of a second type which are different from the transistors of the first type.

In an embodiment, the sixth transistor T6, the eighth transistor T8, and the ninth transistor T9 may be implemented as N-type transistors. In some embodiments, the first transistor T1 to the fifth transistor T5 and the seventh transistor T7 may be implemented as P-type transistors.

For example, the sixth transistor T6, the eighth transistor T8, and the ninth transistor T9 may be implemented as N-type metal oxide thin film transistors. In some embodiments, the first transistor T1 to the fifth transistor T5 and the seventh transistor T7 may be implemented as P-type low temperature polycrystalline silicon (LTPS) thin film transistors.

In an example in which sixth transistor T6 is implemented as an N-type transistor (e.g. the N-type metal oxide thin film transistor), a turn-off characteristic of the sixth transistor T6 may be improved and a leakage current of the sixth transistor T6 may be decreased. Accordingly, the voltage of the n-th control node Q[n] may stably maintain the level of the first power supply voltage VGH and a stability of the gate driver 300 may be improved. In some aspects, as the leakage current of the sixth transistor T6 is decreased, power consumption of the display device 1 may be reduced.

In an example in which eighth transistor T8 is implemented as an N-type transistor (e.g. the N-type metal oxide thin film transistor), a turn-off characteristic of the eighth transistor T8 may be improved and a leakage current of the eighth transistor T8 may be decreased. Accordingly, the n-th gate signal GW[n] output at the n-th output node NO[n] may stably maintain the level of the first power supply voltage VGH and the stability of the gate driver 300 may be improved. In some aspects, as the leakage current of the eighth transistor T8 is decreased, the power consumption of the display device 1 may be reduced.

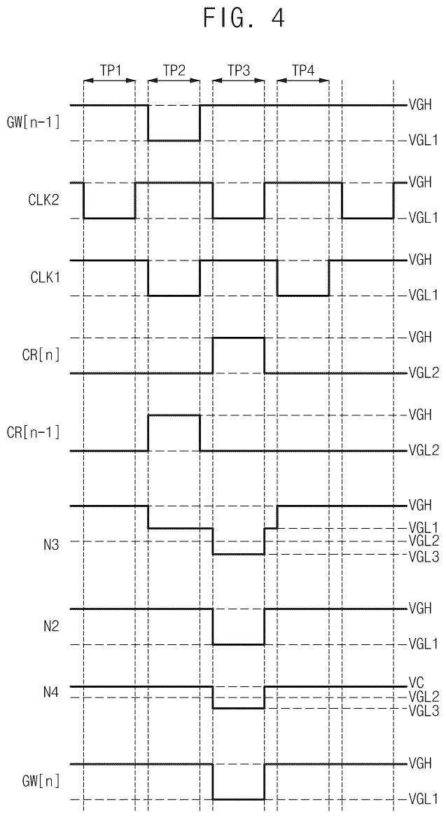

In an example in which ninth transistor T9 is implemented as an N-type transistor (e.g. the N-type metal oxide thin film transistor), a turn-off characteristic of the ninth transistor T9 may be improved and a leakage current of the ninth transistor T9 may be decreased. Accordingly, when the ninth transistor T9 is turned off, a voltage of the third node N3 and a voltage of the fourth node N4 may be different from one another. In an example in which the ninth transistor T9 is turned off, a level of the voltage of the third node N3 may be the same as the level of the first power supply voltage VGH and a level of the voltage of the fourth node N4 may have a fourth power supply voltage level (referring to VC of FIG. 4) lower than the level of the first power supply voltage VGH. As the voltage of the fourth node N4 has the fourth power supply voltage level, stress applied to the sixth transistor T6 may be decreased and a characteristic change of the sixth transistor T6 due to the stress may be decreased. Accordingly, the stability of the gate driver 300 may be improved. In some aspects, as the leakage current of the ninth transistor T9 is decreased, the power consumption of the display device 1 may be reduced.

Descriptions herein of a level of a voltage of a node may refer to a voltage level at the node. Descriptions herein of a level of a voltage of a node having a power supply voltage level (e.g., first power supply voltage VGH, second power supply voltage VGL2, third power supply voltage VGL1, or the like) may refer to the voltage level at the node being equal to the power supply voltage.

As the sixth transistor T6 and the eighth transistor T8 are implemented as N-type transistors (e.g. the N-type metal oxide thin film transistor), the number of the transistors included in the gate driver 300 may be decreased compared to a conventional gate driver. Accordingly, dead space of the display device 1 including the gate driver 300 may be decreased and the power consumption of the display device 1 may be reduced. In some aspects, an integration density of the display device 1 may be increased.

In some aspects, the first clock signal CLK1 may be applied to the first transistor T1 and the fourth transistor T4 through a first clock signal line and the second clock signal CLK2 may be applied to the third transistor T3 through a second clock signal line. A size of the first transistor T1, a size of the third transistor T3, and a size of the fourth transistor T4 when the first transistor T1, the third transistor T3, and the fourth transistor T4 are implemented as P-type transistors may be relatively smaller than a size of the first transistor T1, a size of the third transistor T3, and a size of the fourth transistor T4 when the first transistor T1, the third transistor T3, and the fourth transistor T4 are implemented as N-type transistors. Accordingly, a capacitance of a first parasitic capacitor formed by the first clock signal line and the first transistor T1 may be decreased and a capacitance of a second parasitic capacitor formed by the first clock signal line and the fourth transistor T4 may be decreased. In some aspects, a capacitance of a third parasitic capacitor formed by the second clock signal line and the third transistor T3 may be decreased. Accordingly, the power consumption of the display device 1 due to charging and discharging of the first parasitic capacitor to the third parasitic capacitor may be reduced. That is, the power consumption of the display device 1 may be reduced.

As the first transistor T1 to the fifth transistor T5, and the seventh transistor T7 are implemented as P-type transistors (e.g. the P-type LTPS thin film transistors), a magnitude of a current flowing through each of the first transistor T1 to the fifth transistor T5, and the seventh transistor T7 may be large and the stability of the gate driver 300 may be improved.

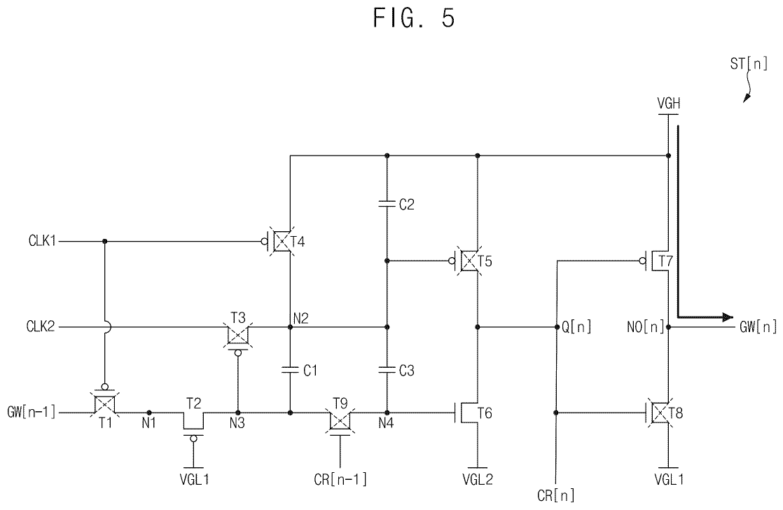

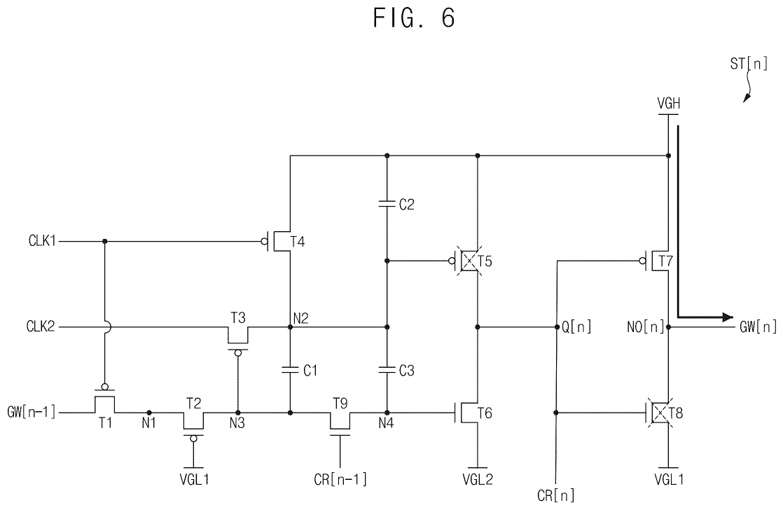

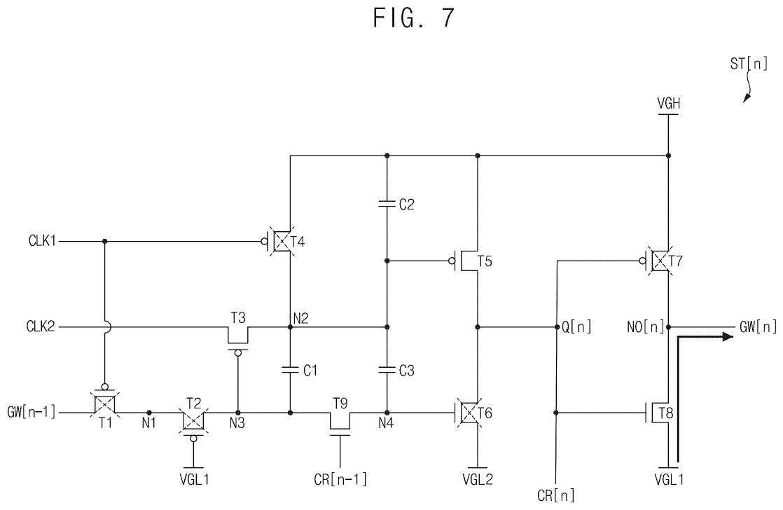

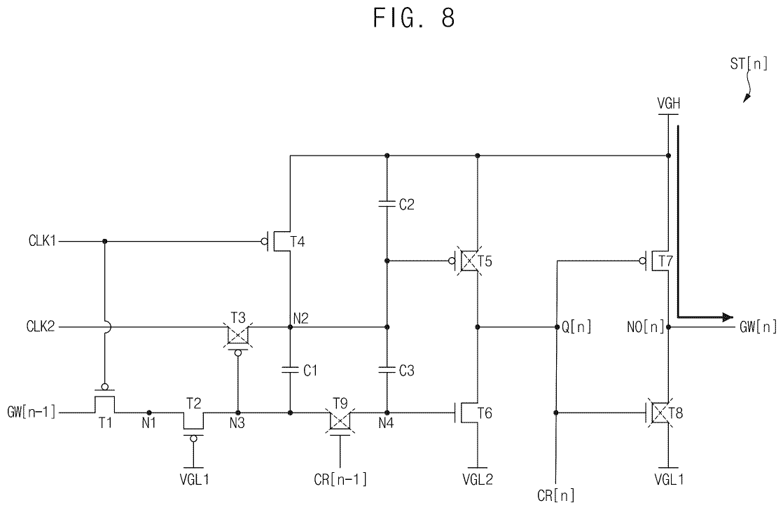

FIG. 4 is a timing diagram illustrating an embodiment of an operation of the stage of FIG. 3, FIG. 5 is a circuit diagram illustrating the operation of the stage of FIG. 3 in a first period TP1 of the timing diagram of FIG. 4, FIG. 6 is a circuit diagram illustrating the operation of the stage of FIG. 3 in a second period TP2 of the timing diagram of FIG. 4, FIG. 7 is a circuit diagram illustrating the operation of the stage of FIG. 3 in a third period TP3 of the timing diagram of FIG. 4, and FIG. 8 is a circuit diagram illustrating the operation of the stage of FIG. 3 in a fourth period TP4 of the timing diagram of FIG. 4.

Referring to FIG. 4, periods in which signals are applied to the n-th stage ST[n] may include the first period TP1, the second period TP2, the third period TP3, and the fourth period TP4.

Referring to FIGS. 4 and 5, the (n−1)-th gate signal GW[n−1] and the first clock signal CLK1 may have the level of the first power supply voltage VGH in the first period TP1. The second clock signal CLK2 may have the level of the third power supply voltage VGL1 in the first period TP1. The (n−1)-th carry signal CR[n−1] may have the level of the second power supply voltage VGL2 in the first period TP1.

A voltage of the first node N1 may have the level of the first power supply voltage VGH and a voltage of the second node N2 may have the level of the first power supply voltage VGH. The voltage of the fourth node N4 may have the fourth power supply voltage level VC. The fourth power supply voltage level VC may be higher than the level of the second power supply voltage VGL2. For example, the fourth power supply voltage level VC may be the same as the level of the third power supply voltage VGL1.

The first transistor T1 may turn off in response to the first clock signal CLK1 and the (n−1)-th gate signal GW[n−1].

The second transistor T2 may turn on in response to the voltage of the first node N1 and the third power supply voltage VGL1. The second transistor T2 may transmit the voltage of the first node N1 to the third node N3. Accordingly, the voltage of the third node N3 may have the level of the first power supply voltage VGH.

The third transistor T3 may turn off in response to the second clock signal CLK2 and the voltage of the third node N3.

The fourth transistor T4 may turn off in response to the first power supply voltage VGH and the first clock signal CLK1.

The fifth transistor T5 may turn off in response to the first power supply voltage VGH and the voltage of the second node N2.

The sixth transistor T6 may turn on in response to the voltage of the fourth node N4 and the second power supply voltage VGL2. A difference between the voltage of the fourth node N4 and the second power supply voltage VGL2 may be greater than a threshold voltage of the sixth transistor T6. Accordingly, the sixth transistor T6 may be turned on. The sixth transistor T6 may transmit the second power supply voltage VGL2 to the n-th control node Q[n]. Accordingly, the n-th control node Q[n] may have the level of the second power supply voltage VGL2. The n-th control node Q[n] may output the n-th carry signal CR[n] having the level of the second power supply voltage VGL2.

The ninth transistor T9 may turn off in response to the (n−1)-th carry signal CR[n−1] and the voltage of the third node N3. A difference between the (n−1)-th carry signal CR[n−1] and the voltage of the third node N3 may be less than a threshold voltage of the ninth transistor T9. Accordingly, the ninth transistor T9 may be turned off. In an example in which the ninth transistor T9 is implemented as an N-type transistor, the turn-off characteristic of the ninth transistor T9 may be improved and the leakage current of the ninth transistor T9 may be decreased. Accordingly, the voltage of the third node N3 and the voltage of the fourth node N4 may be different from one another. Accordingly, as the voltage of the fourth node N4 has the fourth power supply voltage level VC lower than the level of the first power supply voltage VGH, the stress applied to the sixth transistor T6 may be decreased and the characteristic change of the sixth transistor T6 due to the stress may be decreased. Accordingly, the stability of the gate driver 300 may be improved. In some aspects, as the leakage current of the ninth transistor T9 is decreased, the power consumption of the display device 1 may be reduced.

The seventh transistor T7 may turn on in response to the first power supply voltage VGH and the voltage of the n-th control node Q[n]. Accordingly, the seventh transistor T7 may transmit the first power supply voltage VGH to the n-th output node NO[n]. The n-th output node NO[n] may output the n-th gate signal GW[n] having the level of the first power supply voltage VGH.

The eighth transistor T8 may turn off in response to the third power supply voltage VGL1 and the voltage of the n-th control node Q[n]. A difference between the voltage of the n-th control node Q[n] and the third power supply voltage VGL1 may be less than a threshold voltage of the eighth transistor T8. Accordingly, the eighth transistor T8 may be turned off. In an example in which the eighth transistor T8 is implemented as an N-type transistor, the turn-off characteristic of the eighth transistor T8 may be improved and the leakage current of the eighth transistor T8 may be decreased. Accordingly, the n-th gate signal GW[n] output at the n-th output node NO[n] may stably maintain the level of the first power supply voltage VGH and the stability of the gate driver 300 may be improved. In some aspects, as the leakage current of the eighth transistor T8 is decreased, the power consumption of the display device 1 may be reduced.

The voltage of the second node N2 may be stably maintained by the second capacitor C2. In some aspects, as the voltage of the second node N2 is stably maintained, the voltage of the third node N3 and the voltage of the fourth node N4 may be stably maintained.

Referring to FIGS. 4 and 6, the (n−1)-th gate signal GW[n−1] and the first clock signal CLK1 may have the level of the third power supply voltage VGL1 in the second period TP2. The second clock signal CLK2 may have the level of the first power supply voltage VGH in the second period TP2. The (n−1)-th carry signal CR[n−1] may have the level of the first power supply voltage VGH in the second period TP2.

The first transistor T1 may turn on in response to the first clock signal CLK1 and the (n−1)-th gate signal GW[n−1]. The first transistor T1 may transmit the (n−1)-th gate signal GW[n−1] to the first node N1. The voltage of the first node N1 may have the level of the third power supply voltage VGL1.

The second transistor T2 may turn on in response to the voltage of the first node N1 and the third power supply voltage VGL1. The second transistor T2 may transmit the voltage of the first node N1 to the third node N3. Accordingly, the voltage of the third node N3 may have the level of the third power supply voltage VGL1.

The third transistor T3 may turn on in response to the second clock signal CLK2 and the voltage of the third node N3. The third transistor T3 may transmit the second clock signal CLK2 to the second node N2. The voltage of the second node N2 may have the level of the first power supply voltage VGH.

The fourth transistor T4 may turn on in response to the first power supply voltage VGH and the first clock signal CLK1. The fourth transistor T4 may transmit the first power supply voltage VGH to the second node N2. The voltage of the second node N2 may have the level of the first power supply voltage VGH.

The fifth transistor T5 may turn off in response to the first power supply voltage VGH and the voltage of the second node N2.

The ninth transistor T9 may turn on in response to the (n−1)-th carry signal CR[n−1] and the voltage of the third node N3. The difference between the (n−1)-th carry signal CR[n−1] and the voltage of the third node N3 may be greater than the threshold voltage of the ninth transistor T9. Accordingly, the ninth transistor T9 may be turned on. The ninth transistor T9 may transmit the voltage of the third node N3 to the fourth node N4. The voltage of the fourth node N4 may have the level of the third power supply voltage VGL1. The fourth power supply voltage level VC may be the same as the level of the third power supply voltage VGL1.

The sixth transistor T6 may turn on in response to the voltage of the fourth node N4 and the second power supply voltage VGL2. The difference between the voltage of the fourth node N4 and the second power supply voltage VGL2 may be greater than the threshold voltage of the sixth transistor T6. Accordingly, the sixth transistor T6 may be turned on. The sixth transistor T6 may transmit the second power supply voltage VGL2 to the n-th control node Q[n]. Accordingly, the n-th control node Q[n] may have the level of the second power supply voltage VGL2. The n-th control node Q[n] may output the n-th carry signal CR[n] having the level of the second power supply voltage VGL2.

The seventh transistor T7 may turn on in response to the first power supply voltage VGH and the voltage of the n-th control node Q[n]. Accordingly, the seventh transistor T7 may transmit the first power supply voltage VGH to the n-th output node NO[n]. The n-th output node NO[n] may output the n-th gate signal GW[n] having the level of the first power supply voltage VGH.

The eighth transistor T8 may turn off in response to the third power supply voltage VGL1 and the voltage of the n-th control node Q[n]. The difference between the voltage of the n-th control node Q[n] and the third power supply voltage VGL1 may be less than the threshold voltage of the eighth transistor T8. Accordingly, the eighth transistor T8 may be turned off. In an example in which the eighth transistor T8 is implemented as an N-type transistor, the turn-off characteristic of the eighth transistor T8 may be improved and the leakage current of the eighth transistor T8 may be decreased. Accordingly, the n-th gate signal GW[n] output at the n-th output node NO[n] may stably maintain the level of the first power supply voltage VGH and the stability of the gate driver 300 may be improved. In some aspects, as the leakage current of the eighth transistor T8 is decreased, the power consumption of the display device 1 may be reduced.

Referring to FIGS. 4 and 7, the (n−1)-th gate signal GW[n−1] and the first clock signal CLK1 may have the level of the first power supply voltage VGH in the third period TP3. The second clock signal CLK2 may have the level of the third power supply voltage VGL1 in the third period TP3. The (n−1)-th carry signal CR[n−1] may have the level of the second power supply voltage VGL2 in the third period TP3.

The first transistor T1 may turn off in response to the first clock signal CLK1 and the (n−1)-th gate signal GW[n−1].

The second transistor T2 may turn off in response to the voltage of the first node N1 and the third power supply voltage VGL1. The voltage of the first node N1 may maintain the level of the third power supply voltage VGL1.

The third transistor T3 may turn on in response to the second clock signal CLK2 and the voltage of the third node N3. The third transistor T3 may transmit the second clock signal CLK2 to the second node N2. The voltage of the second node N2 may have the level of the third power supply voltage VGL1.

When a level of the voltage of the second node N2 is decreased from the level of the first power supply voltage VGH to the level of the third power supply voltage VGL1, a level of the voltage of the third node N3 may be decreased by a coupling of the first capacitor C1. That is, the voltage of the third node N3 may be bootstrapped. Accordingly, the voltage of the third node N3 may have a fifth power supply voltage level VGL3. The fifth power supply voltage level VGL3 may be lower than the level of the second power supply voltage VGL2. In some aspects, when the level of the voltage of the second node N2 is decreased from the level of the first power supply voltage VGH to the level of the third power supply voltage VGL1, a level of the voltage of the fourth node N4 may be decreased by a coupling of the third capacitor C3. That is, the voltage of the fourth node N4 may be bootstrapped. Accordingly, the fourth node N4 may have the fifth power supply voltage level VGL3.

The fourth transistor T4 may turn off in response to the first power supply voltage VGH and the first clock signal CLK1.

The fifth transistor T5 may turn on in response to the first power supply voltage VGH and the voltage of the second node N2. The fifth transistor T5 may transmit the first power supply voltage VGH to the n-th control node Q[n]. The voltage of the n-th control node Q[n] may have the level of the first power supply voltage VGH.

The ninth transistor T9 may turn on in response to the (n−1)-th carry signal CR[n−1] and the voltage of the third node N3. The difference between the (n−1)-th carry signal CR[n−1] and the voltage of the third node N3 may be greater than the threshold voltage of the ninth transistor T9. Accordingly, the ninth transistor T9 may be turned on.

The sixth transistor T6 may turn off in response to the voltage of the fourth node N4 and the second power supply voltage VGL2. The difference between the voltage of the fourth node N4 and the second power supply voltage VGL2 may be less than the threshold voltage of the sixth transistor T6. Accordingly, the sixth transistor T6 may be turned off. In an example in which the sixth transistor T6 is implemented as an N-type transistor, the turn-off characteristic of the sixth transistor T6 may be improved and the leakage current of the sixth transistor T6 may be decreased. Accordingly, the n-th carry signal CR[n] output at the n-th control node Q[n] may stably maintain the level of the first power supply voltage VGH and the stability of the gate driver 300 may be improved. In some aspects, as the leakage current of the sixth transistor T6 is decreased, the power consumption of the display device 1 may be reduced.

The seventh transistor T7 may turn off in response to the first power supply voltage VGH and the voltage of the n-th control node Q[n].

The eighth transistor T8 may turn on in response to the third power supply voltage VGL1 and the voltage of the n-th control node Q[n]. The difference between the voltage of the n-th control node Q[n] and the third power supply voltage VGL1 may be greater than the threshold voltage of the eighth transistor T8. Accordingly, the eighth transistor T8 may be turned on. The eighth transistor T8 may transmit the third power supply voltage VGL1 to the n-th output node NO[n]. The n-th output node NO[n] may output the n-th gate signal GW[n] having the level of the third power supply voltage VGL1.

Referring to FIGS. 4 and 8, the (n−1)-th gate signal GW[n−1] and the second clock signal CLK2 may have the level of the first power supply voltage VGH in the fourth period TP4. The first clock signal CLK1 may have the level of the third power supply voltage VGL1 in the fourth period TP4. The (n−1)-th carry signal CR[n−1] may have the level of the second power supply voltage VGL2.

The first transistor T1 may turn on in response to the first clock signal CLK1 and the (n−1)-th gate signal GW[n−1]. The first transistor T1 may transmit the (n−1)-th gate signal GW[n−1] to the first node N1. The voltage of the first node N1 may have the level of the first power supply voltage VGH.

The second transistor T2 may turn on in response to the voltage of the first node N1 and the third power supply voltage VGL1. The second transistor T2 may transmit the voltage of the first node N1 to the third node N3. Accordingly, the voltage of the third node N3 may have the level of the first power supply voltage VGH.

The third transistor T3 may turn off in response to the second clock signal CLK2 and the voltage of the third node N3.

The fourth transistor T4 may turn on in response to the first power supply voltage VGH and the first clock signal CLK1. The fourth transistor T4 may transmit the first power supply voltage VGH to the second node N2. The voltage of the second node N2 may have the level of the first power supply voltage VGH.

In an example in which level of the voltage of the second node N2 is increased from the level of the third power supply voltage VGL1 to the level of the first power supply voltage VGH, the level of the voltage of the third node N3 may be increased by the coupling of the third capacitor C3. Accordingly, the voltage of the fourth node N4 may have the fourth power supply voltage level VC. The fourth power supply voltage level VC may be higher than the level of the second power supply voltage VGL2. For example, the fourth power supply voltage level VC may be the same as the level of the third power supply voltage VGL1.

The fifth transistor T5 may turn off in response to the first power supply voltage VGH and the voltage of the second node N2.

The ninth transistor T9 may turn off in response to the (n−1)-th carry signal CR[n−1] and the voltage of the third node N3. The difference between the (n−1)-th carry signal CR[n−1] and the voltage of the third node N3 may be less than the threshold voltage of the ninth transistor T9. Accordingly, the ninth transistor T9 may be turned off. In an example in which the ninth transistor T9 is implemented as an N-type transistor, the turn-off characteristic of the ninth transistor T9 may be improved and the leakage current of the ninth transistor T9 may be decreased. Accordingly, the voltage of the third node N3 and the voltage of the fourth node N4 may be different from one another. Accordingly, as the voltage of the fourth node N4 has the fourth power supply voltage level VC lower than the level of the first power supply voltage VGH, the stress applied to the sixth transistor T6 may be decreased and the characteristic change of the sixth transistor T6 due to the stress may be decreased. Accordingly, the stability of the gate driver 300 may be improved. In some aspects, as the leakage current of the ninth transistor T9 is decreased, the power consumption of the display device 1 may be reduced.

The sixth transistor T6 may turn on in response to the voltage of the fourth node N4 and the second power supply voltage VGL2. The difference between the voltage of the fourth node N4 and the second power supply voltage VGL2 may be greater than the threshold voltage of the sixth transistor T6. Accordingly, the sixth transistor T6 may be turned on. The sixth transistor T6 may transmit the second power supply voltage VGL2 to the n-th control node Q[n]. Accordingly, the n-th control node Q[n] may have the level of the second power supply voltage VGL2. The n-th control node Q[n] may output the n-th carry signal CR[n] having the level of the second power supply voltage VGL2.

The seventh transistor T7 may turn on in response to the first power supply voltage VGH and the voltage of the n-th control node Q[n]. Accordingly, the seventh transistor T7 may transmit the first power supply voltage VGH to the n-th output node NO[n]. The n-th output node NO[n] may output the n-th gate signal GW[n] having the level of the first power supply voltage VGH.

The eighth transistor T8 may turn off in response to the third power supply voltage VGL1 and the voltage of the n-th control node Q[n]. The difference between the voltage of the n-th control node Q[n] and the third power supply voltage VGL1 may be less than the threshold voltage of the eighth transistor T8. Accordingly, the eighth transistor T8 may be turned off. In an example in which the eighth transistor T8 is implemented as an N-type transistor, the turn-off characteristic of the eighth transistor T8 may be improved and the leakage current of the eighth transistor T8 may be decreased. Accordingly, the n-th gate signal GW[n] output at the n-th output node NO[n] may stably maintain the level of the first power supply voltage VGH and the stability of the gate driver 300 may be improved. In some aspects, as the leakage current of the eighth transistor T8 is decreased, the power consumption of the display device 1 may be reduced.

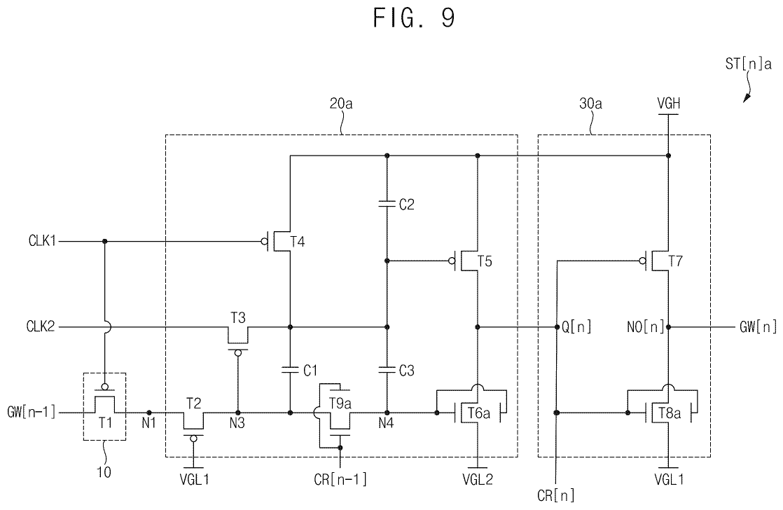

FIG. 9 is a circuit diagram illustrating an embodiment of a stage of FIG. 2.

Referring to FIG. 9, an n-th stage ST[n]a may include the input circuit 10, a control circuit 20a, and an output circuit 30b. The n-th stage ST[n]a is substantially the same as the n-th stage ST[n] of FIG. 3 except that each of a sixth transistor T6a, an eighth transistor T8a, and a ninth transistor T9a further includes a second control electrode. Thus, the same reference numerals will be used to refer to the same or like parts as those described in the previous embodiment of FIG. 3 and any repetitive explanation concerning the above elements will be omitted.

The sixth transistor T6a may include the control electrode connected to the fourth node N4, the first electrode connected to the n-th control node Q[n], and the second electrode receiving the second power supply voltage VGL2. In some aspects, the sixth transistor T6a may further include the second control electrode connected to the control electrode of the sixth transistor T6a.

The eighth transistor T8a may include the control electrode connected to the n-th control node Q[n], the first electrode connected to the n-th output node NO[n], and the second electrode receiving the third power supply voltage VGL1. In some aspects, the eighth transistor T8a may further include the second control electrode connected to the control electrode of the eighth transistor T8a.

The ninth transistor T9a may include the control electrode receiving the (n−1)-th carry signal CR[n−1], the first electrode connected to the third node N3, and the second electrode connected to the fourth node N4. In some aspects, the ninth transistor T9a may further include the second control electrode connected to the control electrode of the ninth transistor T9a.

Characteristics of the sixth transistor T6a, the eighth transistor T8a, and the ninth transistor T9a may be varied due to the stress. For example, the threshold voltage of each of the sixth transistor T6a, the eighth transistor T8a, and the ninth transistor T9a may be varied due to the stress. As each of the sixth transistor T6a, the eighth transistor T8a, and the ninth transistor T9a further includes the second control electrode, the threshold voltage of each of the sixth transistor T6a, the eighth transistor T8a, and the ninth transistor T9a may be not varied. Accordingly, the stability of the gate driver 300 may be improved.

The sixth transistor T6a, the eighth transistor T8a, and the ninth transistor T9a may be implemented as the transistors of the first type. In some embodiments, the first transistor T1 to the fifth transistor T5 and the seventh transistor T7 may be implemented as the transistors of the second type which are different from the transistors of the first type.

In an embodiment, the sixth transistor T6a, the eighth transistor T8a, and the ninth transistor T9a may be implemented as N-type transistors. In some embodiments, the first transistor T1 to the fifth transistor T5 and the seventh transistor T7 may be implemented as P-type transistors.

For example, the sixth transistor T6a, the eighth transistor T8a, and the ninth transistor T9a may be implemented as N-type metal oxide thin film transistors. In some embodiments, the first transistor T1 to the fifth transistor T5 and the seventh transistor T7 may be implemented as P-type LTPS thin film transistors.

In an example in which sixth transistor T6a is implemented as an N-type transistor (e.g. the N-type metal oxide thin film transistor), a turn-off characteristic of the sixth transistor T6a may be improved and the leakage current of the sixth transistor T6a may be decreased. Accordingly, the voltage of the n-th control node Q[n] may stably maintain the level of the first power supply voltage VGH and the stability of the gate driver 300 may be improved. In some aspects, as the leakage current of the sixth transistor T6a is decreased, the power consumption of the display device 1 may be reduced.

In an example in which eighth transistor T8a is implemented as an N-type transistor (e.g. the N-type metal oxide thin film transistor), a turn-off characteristic of the eighth transistor T8a may be improved and the leakage current of the eighth transistor T8a may be decreased. Accordingly, the n-th gate signal GW[n] output at the n-th output node NO[n] may stably maintain the level of the first power supply voltage VGH and the stability of the gate driver 300 may be improved. In some aspects, as the leakage current of the eighth transistor T8a is decreased, the power consumption of the display device 1 may be reduced.

In an example in which ninth transistor T9a is implemented as an N-type transistor (e.g. the N-type metal oxide thin film transistor), a turn-off characteristic of the ninth transistor T9a may be improved and the leakage current of the ninth transistor T9a may be decreased. Accordingly, when the ninth transistor T9a is turned off, the voltage of the third node N3 and the voltage of the fourth node N4 may be different from one another. In an example in which the ninth transistor T9 is turned off, the level of the voltage of the third node N3 may be the same as the level of the first power supply voltage VGH, and the level of the voltage of the fourth node N4 may have the fourth power supply voltage level VC lower than the level of the first power supply voltage VGH. As the voltage of the fourth node N4 has the fourth power supply voltage level VC, the stress applied to the sixth transistor T6a may be decreased and the characteristic change of the sixth transistor T6a due to the stress may be decreased. Accordingly, the stability of the gate driver 300 may be improved. In some aspects, as the leakage current of the ninth transistor T9a is decreased, the power consumption of the display device 1 may be reduced.

As the sixth transistor T6a and the eighth transistor T8a are implemented as N-type transistors (e.g. the N-type metal oxide thin film transistor), the number of the transistors included in the gate driver 300 may be decreased compared to the conventional gate driver. Accordingly, the dead space of the display device 1 including the gate driver 300 may be decreased and the power consumption of the display device 1 may be reduced. In some aspects, the integration density of the display device 1 may be increased.

In some aspects, the first clock signal CLK1 may be applied to the first transistor T1 and the fourth transistor T4 through the first clock signal line and the second clock signal CLK2 may be applied to the third transistor T3 through the second clock signal line. The size of the first transistor T1, the size of the third transistor T3, and the size of the fourth transistor T4 when the first transistor T1, the third transistor T3, and the fourth transistor T4 are implemented as P-type transistors may be relatively smaller than the size of the first transistor T1, the size of the third transistor T3, and the size of the fourth transistor T4 when the first transistor T1, the third transistor T3, and the fourth transistor T4 are implemented as N-type transistors. Accordingly, the capacitance of the first parasitic capacitor formed by the first clock signal line and the first transistor T1 may be decreased and the capacitance of the second parasitic capacitor formed by the first clock signal line and the fourth transistor T4 may be decreased. In some aspects, the capacitance of the third parasitic capacitor formed by the second clock signal line and the third transistor T3 may be decreased. Accordingly, the power consumption of the display device 1 due to charging and discharging of the first parasitic capacitor to the third parasitic capacitor may be reduced. That is, the power consumption of the display device 1 may be reduced.

As the first transistor T1 to the fifth transistor T5, and the seventh transistor T7 are implemented as P-type transistors (e.g. the P-type LTPS thin film transistors), the magnitude of the current flowing through each of the first transistor T1 to the fifth transistor T5, and the seventh transistor T7 may be large and the stability of the gate driver 300 may be improved.

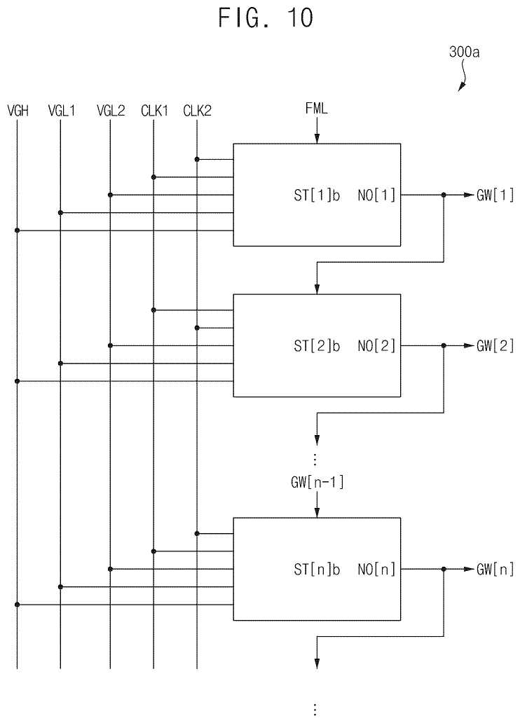

FIG. 10 is a block diagram illustrating an embodiment of stages included in a gate driver 300a of FIG. 1.

Referring to FIG. 10, the gate driver 300a may include the stages. For example, the gate driver 300a may include a first stage ST[1]b and a second stage ST[2]b. In some aspects, the gate driver 300a may include an n-th stage ST[n]b. The stages is substantially the same as the stages of FIG. 2 except for signals applied to the stages of gate driver 300a. Thus, the same reference numerals will be used to refer to the same or like parts as those described in the previous embodiment of FIG. 2 and any repetitive explanation concerning the above elements will be omitted.

Each of the stages may receive the first power supply voltage VGH, the second power supply voltage VGL2, and the third power supply voltage VGL1. In some aspects, each of the stages may receive the first clock signal CLK1 and the second clock signal CLK2.

Each of the stages may receive the input signal. The input signal may be the start signal FLM or the gate signal of the previous stage.

The first stage ST[1]b may receive the first power supply voltage VGH, the second power supply voltage VGL2, the third power supply voltage VGL1, the first clock signal CLK1, and the second clock signal CLK2. In some aspects, the first stage ST[1]b may receive the start signal FLM. In some aspects, the first stage ST[1]b may output the first gate signal GW[1] at the first output node NO[1].

The second stage ST[2]b may receive the first power supply voltage VGH, the second power supply voltage VGL2, the third power supply voltage VGL1, the first clock signal CLK1, and the second clock signal CLK2. In some aspects, the second stage ST[2]b may receive the first gate signal GW[1]. In some aspects, the second stage ST[2]b may output the second gate signal GW[2] at the second output node NO[2].

In this way, the n-th stage ST[n]b may receive the first power supply voltage VGH, the second power supply voltage VGL2, the third power supply voltage VGL1, the first clock signal CLK1, and the second clock signal CLK2. In some aspects, the n-th stage ST[n] may receive the (n−1)-th gate signal GW[n−1]. In some aspects, the n-th stage ST[n] may output the n-th gate signal GW[n] at the n-th output node NO[n].

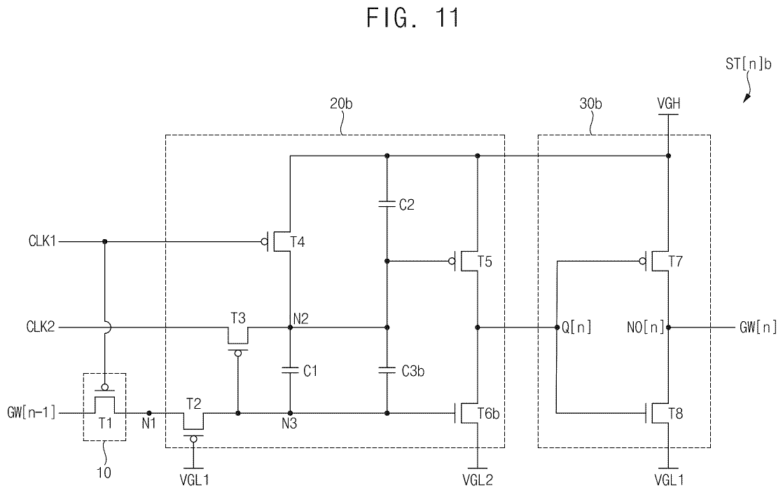

FIG. 11 is a circuit diagram illustrating an embodiment of a stage of FIG. 10.

For convenience of explanation, the stage is an n-th stage ST[n]b which receives the (n−1)-th gate signal GW[n−1] in the present embodiment.

Referring to FIG. 11, the n-th stage ST[n]b may include the input circuit 10, a control circuit 20b, and an output circuit 30b. The n-th stage ST[n]b is substantially the same as the n-th stage ST[n] of FIG. 3 except for the control circuit 20b. Thus, the same reference numerals will be used to refer to the same or like parts as those described in the previous embodiment of FIG. 3 and any repetitive explanation concerning the above elements will be omitted.

The control circuit 20b may include the second transistor T2 to a sixth transistor T6b and the first capacitor C1 to a third capacitor C3b.

The second transistor T2 may include the control electrode receiving the third power supply voltage VGL1, the first electrode connected to the first node N1, and the second electrode connected to the third node N3.

The third transistor T3 may include the control electrode connected to the third node N3, the first electrode receiving the second clock signal CLK2, and the second electrode connected to the second node N2.

The fourth transistor T4 may include the control electrode receiving the first clock signal CLK1, the first electrode receiving the first power supply voltage VGH, and the second electrode connected to the second node N2.

The fifth transistor T5 may include the control electrode connected to the second node N2, the first electrode receiving the first power supply voltage VGH, and the second electrode connected to the n-th control node Q[n].

The sixth transistor T6b may include a control electrode connected to the third node N3, the first electrode connected to the n-th control node Q[n], and the second electrode receiving the second power supply voltage VGL2.

The first capacitor C1 may include the first electrode connected to the second node N2 and the second electrode connected to the third node N3.

The second capacitor C2 may include the first electrode receiving the first power supply voltage VGH and the second electrode connected to the second node N2.

The third capacitor C3b may include the first electrode connected to the second node N2 and a second electrode connected to the third node N3.

The sixth transistor T6b and the eighth transistor T8 may be implemented as the transistors of the first type. In some embodiments, the first transistor T1 to the fifth transistor T5 and the seventh transistor T7 may be implemented as the transistors of the second type which are different from the transistors of the first type.

In an embodiment, the sixth transistor T6b and the eighth transistor T8 may be implemented as N-type transistors. In some embodiments, the first transistor T1 to the fifth transistor T5 and the seventh transistor T7 may be implemented as P-type transistors.

For example, the sixth transistor T6b and the eighth transistor T8 may be implemented as N-type metal oxide thin film transistors. In some embodiments, the first transistor T1 to the fifth transistor T5 and the seventh transistor T7 may be implemented as P-type LTPS thin film transistors.

In an example in which sixth transistor T6b is implemented as an N-type transistor (e.g. the N-type metal oxide thin film transistor), a turn-off characteristic of the sixth transistor T6b may be improved and the leakage current of the sixth transistor T6b may be decreased. Accordingly, the voltage of the n-th control node Q[n] may stably maintain the level of the first power supply voltage VGH and the stability of the gate driver 300a may be improved. In some aspects, as the leakage current of the sixth transistor T6b is decreased, power consumption of the display device 1 may be reduced.

In an example in which eighth transistor T8 is implemented as an N-type transistor (e.g. the N-type metal oxide thin film transistor), the turn-off characteristic of the eighth transistor T8 may be improved and the leakage current of the eighth transistor T8 may be decreased. Accordingly, the n-th gate signal GW[n] output at the n-th output node NO[n] may stably maintain the level of the first power supply voltage VGH and the stability of the gate driver 300a may be improved. In some aspects, as the leakage current of the eighth transistor T8 is decreased, the power consumption of the display device 1 may be reduced.

As the sixth transistor T6b and the eighth transistor T8 are implemented as N-type transistors (e.g. the N-type metal oxide thin film transistor), the number of the transistors included in the gate driver 300 may be decreased compared to the conventional gate driver. Accordingly, the dead space of the display device 1 including the gate driver 300a may be decreased and the power consumption of the display device 1 may be reduced. In some aspects, the integration density of the display device 1 may be increased.

In some aspects, the first clock signal CLK1 may be applied to the first transistor T1 and the fourth transistor T4 through the first clock signal line and the second clock signal CLK2 may be applied to the third transistor T3 through the second clock signal line. The size of the first transistor T1, the size of the third transistor T3, and the size of the fourth transistor T4 when the first transistor T1, the third transistor T3, and the fourth transistor T4 are implemented as P-type transistors may be relatively smaller than the size of the first transistor T1, the size of the third transistor T3, and the size of the fourth transistor T4 when the first transistor T1, the third transistor T3, and the fourth transistor T4 are implemented as N-type transistors. Accordingly, the capacitance of the first parasitic capacitor formed by the first clock signal line and the first transistor T1 may be decreased and the capacitance of the second parasitic capacitor formed by the first clock signal line and the fourth transistor T4 may be decreased. In some aspects, the capacitance of the third parasitic capacitor formed by the second clock signal line and the third transistor T3 may be decreased. Accordingly, the power consumption of the display device 1 due to charging and discharging of the first parasitic capacitor to the third parasitic capacitor may be reduced. That is, the power consumption of the display device 1 may be reduced.

As the first transistor T1 to the fifth transistor T5, and the seventh transistor T7 are implemented as P-type transistors (e.g. the P-type LTPS thin film transistors), the magnitude of the current flowing through each of the first transistor T1 to the fifth transistor T5, and the seventh transistor T7 may be large and the stability of the gate driver 300amay be improved.

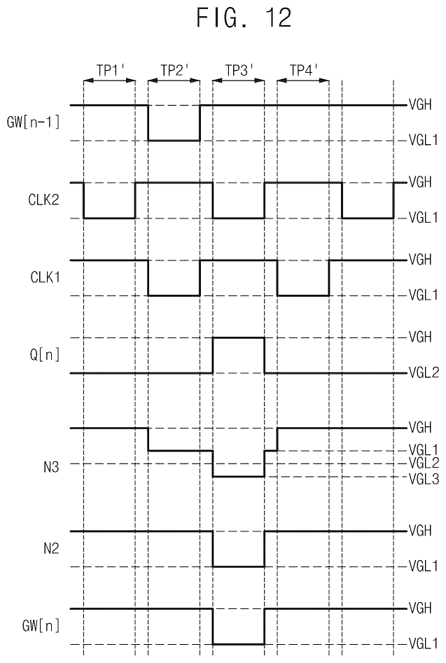

FIG. 12 is a timing diagram illustrating an embodiment of an operation of the stage of FIG. 11.

Referring to FIG. 4, periods in which signals are applied to the n-th stage ST[n]b may include the first period TP1′, the second period TP2′, the third period TP3′, and the fourth period TP4′. The timing diagram is substantially the same as the timing diagram of FIG. 4 except for a voltage applied to the control electrode of the sixth transistor T6b in the first period TP1′ to the fourth period TP4′. Thus, the same reference numerals will be used to refer to the same or like parts as those described in the previous embodiment of FIG. 4 and any repetitive explanation concerning the above elements will be omitted.

As the control electrode of the sixth transistor T6b is connected to the third node N3, the sixth transistor T6b may be turned on or turned off based on the voltage of the third node N3 and the level of the second power supply voltage VGL2.

In the first period TP1′, the sixth transistor T6b may turn on in response to the voltage of the third node N3 and the second power supply voltage VGL2. A difference between the voltage of the third node N3 and the second power supply voltage VGL2 may be greater than the threshold voltage of the sixth transistor T6b. The sixth transistor T6b may transmit the second power supply voltage VGL2 to the n-th control node Q[n]. Accordingly, the n-th control node Q[n] may have the level of the second power supply voltage VGL2.

The eighth transistor T8 may turn off in response to the third power supply voltage VGL1 and the voltage of the n-th control node Q[n]. The difference between the voltage of the n-th control node Q[n] and the third power supply voltage VGL1 may be less than the threshold voltage of the eighth transistor T8. Accordingly, the eighth transistor T8 may be turned off. In an example in which the eighth transistor T8 is implemented as an N-type transistor, the turn-off characteristic of the eighth transistor T8 may be improved and the leakage current of the eighth transistor T8 may be decreased. Accordingly, the n-th gate signal GW[n] output at the n-th output node NO[n] may stably maintain the level of the first power supply voltage VGH and the stability of the gate driver 300a may be improved. In some aspects, as the leakage current of the eighth transistor T8 is decreased, the power consumption of the display device 1 may be reduced.

In the second period TP2′, the sixth transistor T6b may turn on in response to the voltage of the third node N3 and the second power supply voltage VGL2. The difference between the voltage of the third node N3 and the second power supply voltage VGL2 may be greater than the threshold voltage of the sixth transistor T6b. Accordingly, the sixth transistor T6b may be turned on. The sixth transistor T6b may transmit the second power supply voltage VGL2 to the n-th control node Q[n]. Accordingly, the n-th control node Q[n] may have the level of the second power supply voltage VGL2.

The eighth transistor T8 may turn off in response to the third power supply voltage VGL1 and the voltage of the n-th control node Q[n]. The difference between the voltage of the n-th control node Q[n] and the third power supply voltage VGL1 may be less than the threshold voltage of the eighth transistor T8. Accordingly, the eighth transistor T8 may be turned off. In an example in which the eighth transistor T8 is implemented as an N-type transistor, the turn-off characteristic of the eighth transistor T8 may be improved and the leakage current of the eighth transistor T8 may be decreased. Accordingly, the n-th gate signal GW[n] output at the n-th output node NO[n] may stably maintain the level of the first power supply voltage VGH and the stability of the gate driver 300a may be improved. In some aspects, as the leakage current of the eighth transistor T8 is decreased, the power consumption of the display device 1 may be reduced.

In the third period TP3′, the sixth transistor T6b may turn off in response to the voltage of the third node N3 and the second power supply voltage VGL2. The difference between the voltage of the third node N3 and the second power supply voltage VGL2 may be less than the threshold voltage of the sixth transistor T6b. Accordingly, the sixth transistor T6b may be turned off. In an example in which the sixth transistor T6b is implemented as an N-type transistor, the turn-off characteristic of the sixth transistor T6b may be improved and the leakage current of the sixth transistor T6b may be decreased. Accordingly, the voltage of the n-th control node Q[n] may stably maintain the level of the first power supply voltage VGH and the stability of the gate driver 300a may be improved. In some aspects, as the leakage current of the sixth transistor T6b is decreased, the power consumption of the display device 1 may be reduced.

The eighth transistor T8 may turn on in response to the third power supply voltage VGL1 and the voltage of the n-th control node Q[n]. The difference between the voltage of the n-th control node Q[n] and the third power supply voltage VGL1 may be greater than the threshold voltage of the eighth transistor T8. Accordingly, the eighth transistor T8 may be turned on. The eighth transistor T8 may transmit the third power supply voltage VGL1 to the n-th output node NO[n]. The n-th output node NO[n] may output the n-th gate signal GW[n] having the level of the third power supply voltage VGL1.

In the fourth period TP4′, the sixth transistor T6b may turn on in response to the voltage of the third node N3 and the second power supply voltage VGL2. The difference between the voltage of the third node N3 and the second power supply voltage VGL2 may be greater than the threshold voltage of the sixth transistor T6b. Accordingly, the sixth transistor T6b may be turned on. The sixth transistor T6b may transmit the second power supply voltage VGL2 to the n-th control node Q[n]. Accordingly, the n-th control node Q[n] may have the level of the second power supply voltage VGL2.

The eighth transistor T8 may turn off in response to the third power supply voltage VGL1 and the voltage of the n-th control node Q[n]. The difference between the voltage of the n-th control node Q[n] and the third power supply voltage VGL1 may be less than the threshold voltage of the eighth transistor T8. Accordingly, the eighth transistor T8 may be turned off. In an example in which the eighth transistor T8 is implemented as an N-type transistor, the turn-off characteristic of the eighth transistor T8 may be improved and the leakage current of the eighth transistor T8 may be decreased. Accordingly, the n-th gate signal GW[n] output at the n-th output node NO[n] may stably maintain the level of the first power supply voltage VGH and the stability of the gate driver 300a may be improved. In some aspects, as the leakage current of the eighth transistor T8 is decreased, the power consumption of the display device 1 may be reduced.

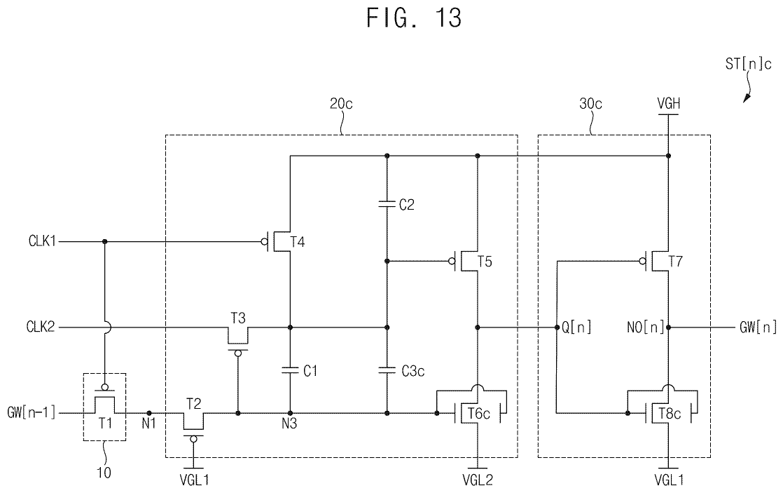

FIG. 13 is a circuit diagram illustrating an embodiment of a stage of FIG. 10.

For convenience of explanation, the stage is an n-th stage ST[n]c which receives the (n−1)-th gate signal GW[n−1] in the present embodiment.

Referring to FIG. 13, the n-th stage ST[n]c may include the input circuit 10, a control circuit 20c, and an output circuit 30c. The n-th stage ST[n]c is substantially the same as the n-th stage ST[n]b of FIG. 11 except that each of a sixth transistor T6c and an eighth transistor T8c further includes a second control electrode. Thus, the same reference numerals will be used to refer to the same or like parts as those described in the previous embodiment of FIG. 11 and any repetitive explanation concerning the above elements will be omitted.

The sixth transistor T6c may include the control electrode connected to the third node N3, the first electrode connected to the n-th control node Q[n], and the second electrode receiving the second power supply voltage VGL2. In some aspects, the sixth transistor T6c may further include the second control electrode connected to the control electrode of the sixth transistor T6c.

The eighth transistor T8c may include the control electrode connected to the n-th control node Q[n], the first electrode connected to the n-th output node NO[n], and the second electrode receiving the third power supply voltage VGL1. In some aspects, the eighth transistor T8c may further include the second control electrode connected to the control electrode of the eighth transistor T8c.

Characteristics of the sixth transistor T6c and the eighth transistor T8c may be varied due to the stress. For example, the threshold voltage of each of the sixth transistor T6c and the eighth transistor T8c may be varied due to the stress. Accordingly, for example, as further including the second control electrode at each of the sixth transistor T6c and the eighth transistor T8c may prevent or mitigate any variance of the threshold voltage of each of the sixth transistor T6c, the eighth transistor T8c, and the ninth transistor T9a. Accordingly, the stability of the gate driver 300a may be improved.

The sixth transistor T6c and the eighth transistor T8c may be implemented as the transistors of the first type. In some embodiments, the first transistor T1 to the fifth transistor T5 and the seventh transistor T7 may be implemented as the transistors of the second type which are different from the transistors of the first type.

In an embodiment, the sixth transistor T6c and the eighth transistor T8c may be implemented as N-type transistors. In some embodiments, the first transistor T1 to the fifth transistor T5 and the seventh transistor T7 may be implemented as P-type transistors.

For example, the sixth transistor T6c and the eighth transistor T8c may be implemented as N-type metal oxide thin film transistors. In some embodiments, the first transistor T1 to the fifth transistor T5 and the seventh transistor T7 may be implemented as P-Type type LTPS thin film transistors.

In an example in which sixth transistor T6c is implemented as an N-type transistor (e.g. the N-type metal oxide thin film transistor), a turn-off characteristic of the sixth transistor T6c may be improved and the leakage current of the sixth transistor T6c may be decreased. Accordingly, the voltage of the n-th control node Q[n] may stably maintain the level of the first power supply voltage VGH and the stability of the gate driver 300a may be improved. In some aspects, as the leakage current of the sixth transistor T6c is decreased, the power consumption of the display device 1 may be reduced.

In an example in which eighth transistor T8c is implemented as an N-type transistor (e.g. the N-type metal oxide thin film transistor), a turn-off characteristic of the eighth transistor T8c may be improved and the leakage current of the eighth transistor T8c may be decreased. Accordingly, the n-th gate signal GW[n] output at the n-th output node NO[n] may stably maintain the level of the first power supply voltage VGH and the stability of the gate driver 300a may be improved. In some aspects, as the leakage current of the eighth transistor T8c is decreased, the power consumption of the display device 1 may be reduced.

As the sixth transistor T6c and the eighth transistor T8c are implemented as N-type transistors (e.g. the N-type metal oxide thin film transistor), the number of the transistors included in the gate driver 300a may be decreased compared to the conventional gate driver. Accordingly, the dead space of the display device 1 including the gate driver 300a may be decreased and the power consumption of the display device 1 may be reduced. In some aspects, the integration density of the display device 1 may be increased.

In some aspects, the first clock signal CLK1 may be applied to the first transistor T1 and the fourth transistor T4 through the first clock signal line and the second clock signal CLK2 may be applied to the third transistor T3 through the second clock signal line. The size of the first transistor T1, the size of the third transistor T3, and the size of the fourth transistor T4 when the first transistor T1, the third transistor T3, and the fourth transistor T4 are implemented as P-type transistors may be relatively smaller than the size of the first transistor T1, the size of the third transistor T3, and the size of the fourth transistor T4 when the first transistor T1, the third transistor T3, and the fourth transistor T4 are implemented as N-type transistors. Accordingly, the capacitance of the first parasitic capacitor formed by the first clock signal line and the first transistor T1 may be decreased and the capacitance of the second parasitic capacitor formed by the first clock signal line and the fourth transistor T4 may be decreased. In some aspects, the capacitance of the third parasitic capacitor formed by the second clock signal line and the third transistor T3 may be decreased. Accordingly, the power consumption of the display device 1 due to charging and discharging of the first parasitic capacitor to the third parasitic capacitor may be reduced. That is, the power consumption of the display device 1 may be reduced.

As the first transistor T1 to the fifth transistor T5, and the seventh transistor T7 are implemented as P-type transistors (e.g. the P-type LTPS thin film transistors), the magnitude of the current flowing through each of the first transistor T1 to the fifth transistor T5, and the seventh transistor T7 may be large and the stability of the gate driver 300a may be improved.

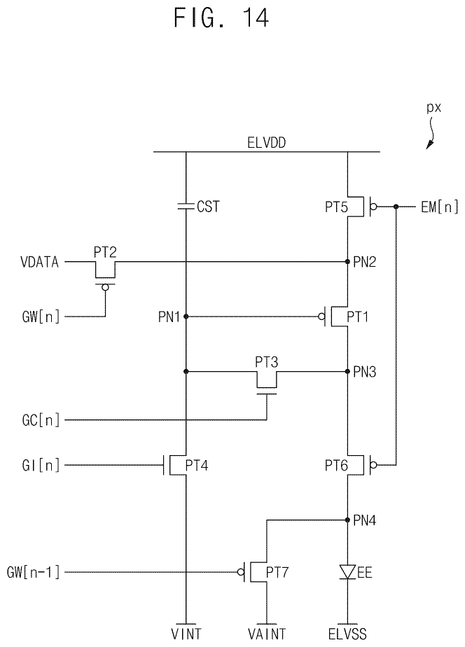

FIG. 14 is a circuit diagram illustrating an embodiment of a pixel PX included in the display panel 100 of FIG. 1.

Referring to FIG. 14, the pixel PX may include a first pixel transistor PT1 to a seventh pixel transistor PT7, a storage capacitor CST, and a light emitting element EE, but the pixel PX is not limited thereto.

In an embodiment, the gate signals output from the stages included in the gate driver 300 may be the writing gate signal applied to the second pixel transistor PT2. For example, the n-th gate signal GW[n] output from the n-th stage ST[n] may be the writing gate signal GW[n] applied to the second pixel transistor PT2.

The first pixel transistor PT1 may include a control electrode connected to a first pixel node PN1, a first electrode connected to a second pixel node PN2, and a second electrode connected to a third pixel node PN3. The first pixel transistor PT1 may generate a driving current based on a difference between a voltage of the first pixel node PN1 and a voltage of the second pixel node PN2.

The second pixel transistor PT2 may include a control electrode receiving the writing gate signal GW[n], a first electrode receiving the data voltage VDATA, and a second electrode connected to the second pixel node PN2. The second pixel transistor PT2 may transmit the data voltage VDATA to the second pixel node PN2 in response to the writing gate signal GW[n].

The third pixel transistor PT3 may include a control electrode receiving the compensation gate signal GC[n], a first electrode connected to the third pixel node PN3, and a second electrode connected to the first pixel node PN1. The third pixel transistor PT3 may diode-connect the first pixel transistor PT1 in response to the compensation gate signal GC[n].

The fourth pixel transistor PT4 may include a control electrode receiving the initialization gate signal GI[n], a first electrode receiving an initialization voltage VINT, and a second electrode connected to the first pixel node PN1. The fourth pixel transistor PT4 may transmit the initialization voltage VINT to the first pixel node PN1 in response to the initialization gate signal GC[n].

The fifth pixel transistor PT5 may include a control electrode receiving the emission signal EM[n], a first electrode receiving a first pixel power supply voltage ELVDD, and a second electrode connected to the second pixel node PN2.

The sixth pixel transistor PT6 may include a control electrode receiving the emission signal EM[n], a first electrode connected to the third pixel node PN3, and a second electrode connected to a fourth pixel node PN4.

The fifth pixel transistor PT5 and the sixth pixel transistor PT6 may control an emission of the light emitting element EE in response to the emission signal EM[n].

The seventh pixel transistor PT7 may include a control electrode receiving a previous writing gate signal GW[n−1], a first electrode receiving an anode initialization voltage VAINT, and a second electrode connected to the fourth pixel node PN4. The seventh pixel transistor PT7 may transmit the anode initialization voltage VAINT to the fourth pixel node PN4 in response to the previous writing gate signal GW[n−1].

The storage capacitor CST may include a first electrode receiving the first pixel power supply voltage ELVDD and a second electrode connected to the first pixel node PN1. The storage capacitor CST may store the data voltage VDATA.

The light emitting element EE may include an anode electrode connected to the fourth pixel node PN4 and an cathode electrode receiving a second pixel power supply voltage ELVSS. The light emitting element EE may emit a light based on the driving current generated by the first pixel transistor PT1.

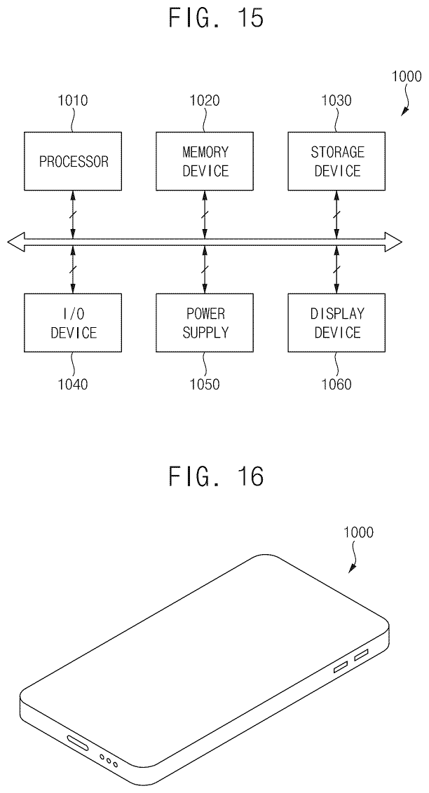

FIG. 15 is a block diagram illustrating an electronic device 1000 according to embodiments of the present disclosure and FIG. 16 is a diagram illustrating an embodiment in which the electronic device 1000 of FIG. 15 is implemented as a smart phone.

Referring to FIGS. 15 and 16, the electronic device 1000 may include a processor 1010, a memory device 1020, a storage device 1030, an input/output (I/O) device 1040, a power supply 1050 and a display device 1060. The display device 1060 may be the display device 1 of FIG. 1. In some aspects, the electronic device 1000 may further include ports for communicating with a video card, a sound card, a memory card, a universal serial bus (USB) device, other electronic device, and the like.

In an embodiment, as illustrated in FIG. 16, the electronic device 1000 may be implemented as the smart phone. However, the electronic device 1000 is not limited thereto. For example, the electronic device 1000 may be implemented as a cellular phone, a video phone, a smart pad, a smart watch, a tablet PC, a car navigation system, a computer monitor, a laptop, a head mounted display (HMD) device, and the like.

The processor 1010 may perform various computing functions. The processor 1010 may be a microprocessor, a central processing unit (CPU), an application processor (AP), and the like. The processor 1010 may be coupled to other components via an address bus, a control bus, a data bus, and the like. Further, the processor 1010 may be coupled to an extended bus such as, for example, a peripheral component interconnection (PCI) bus.

The processor 1010 may output the input image data IMG and the input control signal CONT to the driving controller 200 of FIG. 1.

The memory device 1020 may store data for operations of the electronic device 1000. For example, the memory device 1020 may include at least one non-volatile memory device such as, for example, an erasable programmable read-only memory (EPROM) device, an electrically erasable programmable read-only memory (EEPROM) device, a flash memory device, a phase change random access memory (PRAM) device, a resistance random access memory (RRAM) device, a nano floating gate memory (NFGM) device, a polymer random access memory (PoRAM) device, a magnetic random access memory (MRAM) device, a ferroelectric random access memory (FRAM) device, and the like and/or at least one volatile memory device such as, for example, a dynamic random access memory (DRAM) device, a static random access memory (SRAM) device, a mobile DRAM device, and the like.

The storage device 1030 may include a solid state drive (SSD) device, a hard disk drive (HDD) device, a CD-ROM device, and the like.

The I/O device 1040 may include an input device such as, for example, a keyboard, a keypad, a mouse device, a touch-pad, a touch-screen, and the like, and an output device such as, for example, a printer, a speaker, and the like. According to an embodiment, the I/O device 1040 may include the display device 1060.

The power supply 1050 may provide power for operations of the electronic device 1000.

The display device 1060 may be connected to other components through buses or other communication links.

Aspects of the present disclosure may be applied to a display device and an electronic device including the display device. For example, embodiments of the present disclosure may be applied to a television (TV), a digital TV, a 3D TV, a mobile phone, a smart phone, a tablet computer, a laptop computer, a personal computer (PC), a household electronic device, a personal digital assistant (PDA), a portable multimedia player (PMP), a digital camera, a music player, a portable game console, a navigation device, or the like.

The foregoing is illustrative of the embodiments of the present disclosure and is not to be construed as limiting thereof. Although example embodiments supported by the present disclosure have been described, those skilled in the art will readily appreciate that many modifications are possible in the embodiments without materially departing from the novel teachings and advantages of the embodiments of the present disclosure. Accordingly, all such modifications are intended to be included within the scope of the embodiments of the present disclosure as defined in the claims. In the claims, means-plus-function clauses are intended to cover the structures described herein as performing the recited function and not only structural equivalents but also equivalent structures. Therefore, it is to be understood that the foregoing is illustrative of the embodiments of the present disclosure and is not to be construed as limited to the specific embodiments disclosed, and that modifications to the disclosed embodiments, as well as other embodiments, are intended to be included within the scope of the appended claims. Example embodiments supported by the present disclosure are defined by the following claims, with equivalents of the claims to be included therein.

What is claimed is:

1. A gate driver comprising:
an input circuit which transmits an input signal to a control circuit based on a first clock signal;
the control circuit which controls a voltage of a control node based on the input signal, the first clock signal, a second clock signal, and a voltage control signal; and
an output circuit which outputs a gate signal based on the voltage of the control node,
wherein the control circuit comprises:
a fifth transistor comprising a control electrode connected to a second node, a first electrode which receives a first power supply voltage, and a second electrode connected to the control node;
a sixth transistor comprising a control electrode connected to a fourth node, a first electrode connected to the control node, and a second electrode which receives a second power supply voltage; and
a ninth transistor comprising a control electrode which receives the voltage control signal, a first electrode connected to a third node, and a second electrode connected to the fourth node,
wherein:
the control circuit transmits one of the first power supply voltage and the second power supply voltage to the control node, and
the output circuit outputs one of the first power supply voltage and a third power supply voltage as the gate signal.

2. The gate driver of claim 1, wherein:
the input circuit comprises a first transistor comprising a control electrode which receives the first clock signal, a first electrode which receives the input signal, and a second electrode connected to a first node, and
the control circuit further comprises:
a second transistor comprising a control electrode which receives the third power supply voltage, a first electrode connected to the first node, and a second electrode connected to the third node;
a third transistor comprising a control electrode connected to the third node, a first electrode which receives the second clock signal, and a second electrode connected to the second node;
a fourth transistor comprising a control electrode which receives the first clock signal, a first electrode which receives the first power supply voltage, and a second electrode connected to the second node;
a first capacitor comprising a first electrode connected to the second node and a second electrode connected to the third node;
a second capacitor comprising a first electrode which receives the first power supply voltage and a second electrode connected to the second node; and
a third capacitor comprising a first electrode connected to the second node and a second electrode connected to the fourth node.

3. The gate driver of claim 2, wherein the output circuit comprises:
a seventh transistor comprising a control electrode connected to the control node, a first electrode which receives the first power supply voltage, and a second electrode connected to an output node; and
an eighth transistor comprising a control electrode connected to the control node, a first electrode connected to the output node, and a second electrode which receives the third power supply voltage.

4. The gate driver of claim 3, wherein:
a level of the first power supply voltage is higher than a level of the third power supply voltage, and
the level of the third power supply voltage is higher than a level of the second power supply voltage.

5. The gate driver of claim 3, wherein:
the sixth transistor, the eighth transistor, and the ninth transistor are implemented as transistors of a first type, and
the first transistor to the fifth transistor and the seventh transistor are implemented as transistors of a second type which are different from the transistors of the first type.

6. The gate driver of claim 5, wherein the sixth transistor, the eighth transistor, and the ninth transistor are implemented as N-type transistors.

7. The gate driver of claim 5, wherein the first transistor to the fifth transistor and the seventh transistor are implemented as P-type transistors.

8. The gate driver of claim 3, wherein:
the sixth transistor further comprises a second control electrode connected to the control electrode of the sixth transistor,
the eighth transistor further comprises a second control electrode connected to the control electrode of the eighth transistor, and
the ninth transistor further comprises a second control electrode connected to the control electrode of the ninth transistor.

9. A display device comprising:
a display panel comprising pixels;
a gate driver which outputs a gate signal to the pixels; and
a data driver which outputs a data voltage to the pixels,
wherein the gate driver comprises:
an input circuit which transmits an input signal to a control circuit based on a first clock signal;
the control circuit which controls a voltage of a control node based on the input signal, the first clock signal, a second clock signal, and a voltage control signal; and
an output circuit which outputs the gate signal based on the voltage of the control node,
wherein the control circuit comprises:
a fifth transistor comprising a control electrode connected to a second node, a first electrode which receives a first power supply voltage, and a second electrode connected to the control node;
a sixth transistor comprising a control electrode connected to a fourth node, a first electrode connected to the control node, and a second electrode which receives a second power supply voltage; and
a ninth transistor comprising a control electrode which receives the voltage control signal, a first electrode connected to a third node, and a second electrode connected to the fourth node,
wherein:
the control circuit transmits one of the first power supply voltage and the second power supply voltage to the control node, and
the output circuit outputs one of the first power supply voltage and a third power supply voltage as the gate signal.

10. The display device of claim 9, wherein:
the input circuit comprises a first transistor comprising a control electrode which receives the first clock signal, a first electrode which receives the input signal, and a second electrode connected to a first node, and
the control circuit further comprises:
a second transistor comprising a control electrode which receives the third power supply voltage, a first electrode connected to the first node, and a second electrode connected to the third node;
a third transistor comprising a control electrode connected to the third node, a first electrode which receives the second clock signal, and a second electrode connected to the second node;
a fourth transistor comprising a control electrode which receives the first clock signal, a first electrode which receives the first power supply voltage, and a second electrode connected to the second node;
a first capacitor comprising a first electrode connected to the second node and a second electrode connected to the third node;
a second capacitor comprising a first electrode which receives the first power supply voltage and a second electrode connected to the second node; and
a third capacitor comprising a first electrode connected to the second node and a second electrode connected to the fourth node.

11. The display device of claim 10, wherein the output circuit comprises:
a seventh transistor comprising a control electrode connected to the control node, a first electrode which receives the first power supply voltage, and a second electrode connected to an output node; and
an eighth transistor comprising a control electrode connected to the control node, a first electrode connected to the output node, and a second electrode which receives the third power supply voltage.

12. The display device of claim 11, wherein:
a level of the first power supply voltage is higher than a level of the third power supply voltage, and
the level of the third power supply voltage is higher than a level of the second power supply voltage.

13. The display device of claim 11, wherein:
the sixth transistor, the eighth transistor, and the ninth transistor are implemented as transistors of a first type, and
the first transistor to the fifth transistor and the seventh transistor are implemented as transistors of a second type which are different from the transistors of the first type.

14. The display device of claim 13, wherein the sixth transistor, the eighth transistor, and the ninth transistor are implemented as N-type transistors.

15. The display device of claim 13, wherein the first transistor to the fifth transistor and the seventh transistor are implemented as P-type transistors.

16. The display device of claim 11, wherein:
the sixth transistor further comprises a second control electrode connected to the control electrode of the sixth transistor,
the eighth transistor further comprises a second control electrode connected to the control electrode of the eighth transistor, and
the ninth transistor further comprises a second control electrode connected to the control electrode of the ninth transistor.

17. An electronic device comprising:
a processor which outputs an input control signal and input image data;
a display panel comprising pixels;
a gate driver which outputs a gate signal to the pixels;
a data driver which outputs a data voltage to the pixels; and
a driving controller which controls the gate driver and the data driver based on the input control signal and the input image data,
wherein the gate driver comprises:
an input circuit which transmits an input signal to a control circuit based on a first clock signal;
the control circuit which controls a voltage of a control node based on the input signal, the first clock signal, a second clock signal, and a voltage control signal; and
an output circuit which outputs the gate signal based on the voltage of the control node,
wherein the control circuit comprises:
a fifth transistor comprising a control electrode connected to a second node, a first electrode which receives a first power supply voltage, and a second electrode connected to the control node;
a sixth transistor comprising a control electrode connected to a fourth node, a first electrode connected to the control node, and a second electrode which receives a second power supply voltage; and
a ninth transistor comprising a control electrode which receives the voltage control signal, a first electrode connected to a third node, and a second electrode connected to the fourth node,
wherein:
the control circuit transmits one of the first power supply voltage and the second power supply voltage to the control node, and
the output circuit outputs one of the first power supply voltage and a third power supply voltage as the gate signal.

18. The electronic device of claim 17, wherein:
the input circuit comprises a first transistor comprising a control electrode which receives the first clock signal, a first electrode which receives the input signal, and a second electrode connected to a first node, and
the control circuit further comprises:
a second transistor comprising a control electrode which receives the third power supply voltage, a first electrode connected to the first node, and a second electrode connected to the third node;
a third transistor comprising a control electrode connected to the third node, a first electrode which receives the second clock signal, and a second electrode connected to the second node;
a fourth transistor comprising a control electrode which receives the first clock signal, a first electrode which receives the first power supply voltage, and a second electrode connected to the second node;
a first capacitor comprising a first electrode connected to the second node and a second electrode connected to the third node;
a second capacitor comprising a first electrode which receives the first power supply voltage and a second electrode connected to the second node; and
a third capacitor comprising a first electrode connected to the second node and a second electrode connected to the fourth node.

19. The electronic device of claim 18, wherein the output circuit comprises:
a seventh transistor comprising a control electrode connected to the control node, a first electrode which receives the first power supply voltage, and a second electrode connected to an output node; and
an eighth transistor comprising a control electrode connected to the control node, a first electrode connected to the output node, and a second electrode which receives the third power supply voltage.

20. The electronic device of claim 19, wherein:
a level of the first power supply voltage is higher than a level of the third power supply voltage, and
the level of the third power supply voltage is higher than a level of the second power supply voltage.
